(19) United States
(12) Patent Application Publication
(10) Pub. No.: US 2024/0249580 A1
(43) Pub. Date: Jul. 25, 2024

(54) CHANGE MACHINE

(71) Applicant: TOSHIBA TEC KABUSHIKI KAISHA, Tokyo (JP)

(72) Inventor: Toshiki Matsuo, Sunto Shizuoka (JP)

(21) Appl. No.: 18/489,026

(22) Filed: Oct. 18, 2023

(30) Foreign Application Priority Data
Jan. 20, 2023 (JP) 2023-007272

(51) Int. Cl. G07D 1/06; G06Q 20/20; G07D 3/16; G07D 5/00

(52) U.S. Cl. CPC G07D 1/06; G06Q 20/20; G07D 3/16; G07D 5/00

(57) ABSTRACT

A change machine includes a denomination discriminating unit to discriminate denominations of deposited coins or bills, a counting unit to count the number of the coins or the bills for each of the denominations, a storage unit to store a limit number of the coins or the bills, a number determining unit to determine a denomination of the coins or the bills, the number of which counted in one transaction reached the limit number, an operator determining unit to determine which of a customer and a store staff member deposited the coins or the bills, and a deposit control unit to, if the customer deposited the coins or the bills, return the coins or the bills of the denomination and, if the store staff member deposited the coins or the bills, allows storage of the coins or the bills of the denomination.

### CROSS-REFERENCE TO RELATED APPLICATION

This application is based upon and claims the benefit of priority from Japanese Patent Application No. 2023-007272, filed Jan. 20, 2023, the entire contents of which are incorporated herein by reference.

### FIELD

Embodiments described herein relate generally to a change machine.

### BACKGROUND

Heretofore, in stores such as a supermarket, a volume retail store, and a convenience store, a self-service-type POS (Point of Sales) terminal (hereinafter referred to as “self-service POS terminal”) is introduced as a device relating to sales of commodities and the like. In the self-service POS terminal, a customer performs registration operation and checkout operation for commodities by himself or herself. Furthermore, a semi-self-service-type POS system (hereinafter referred to as “semi-self-service POS”) is introduced in relation to sales of commodities and the like. The semi-self-service POS includes a commodity registration device and a checkout device. An operator such as a store clerk performs registration operation for commodities in the commodity registration device. A customer himself or herself performs checkout operation in the checkout device.

The checkout device in the self-service POS terminal or the semi-self-service POS explained above includes a change machine inside a housing in preparation for checkout by cash. The change machine is, for example, a coin change machine. The change machine is, for example, a bill change machine. If performing checkout by cash, the customer deposits cash to the change machine to make payment in the checkout device of the self-service POS terminal or the semi-self-service POS. If there is change, the change machine dispenses change to the customer.

Recently, as a normal POS terminal in which a store staff member such as a store clerk performs operation other than the self-service POS terminal 1 or the semi-self-service POS explained above, there is a device including a change machine in which a depositing port and a dispensing port are disposed on a customer side in order to allow the customer himself or herself to pay cash as deposit money and receive change.

Incidentally, in the change machine explained above, the customer sometimes deposits a large quantity of coins or bills to the change machine as a price for commodity purchase. For example, the customer sometimes deposits a large quantity of one-yen coins and ten-yen coins to the coin change machine in the checkout operation in the checkout device. If the large quantity of coins are deposited to the coin change machine in this way, problems occur in that, for example, a processing time increases because of the coin deposit in the coin change machine, possibility of occurrence of a coin jam in the coin change machine increases, and a coin storing unit in the coin change machine is quickly filled and the number of times of coin collection increases. The same problems occur in the bill change machine.

Therefore, there is a change machine that limits the number of coins or bills that can be deposited to the change machine in one transaction (for example, limits the number to twenty) and disables coins or bills exceeding the limit number to be deposited at a time.

However, for example, if a store staff member deposits change reserve money to the change machine, the store staff member sometimes deposits coins or bills exceeding the limit number at a time. Therefore, improvement is requested.

### BRIEF DESCRIPTION OF THE DRAWINGS

FIG. 1 is a perspective view illustrating an exterior of a self-service POS terminal according to an embodiment;

FIG. 2 is a perspective view illustrating the exterior of the self-service POS terminal, a door of which is opened;

FIG. 3 is a block diagram illustrating a hardware configuration of the self-service POS terminal;

FIG. 4 is a perspective view illustrating an exterior of a coin change machine;

FIG. 5 is a block diagram illustrating a hardware configuration of the coin change machine;

FIG. 6 is a perspective view illustrating an exterior of a bill change machine;

FIG. 7 is a block diagram illustrating a hardware configuration of the bill change machine;

FIG. 8 is a flowchart illustrating a flow of control processing for the self-service POS terminal;

FIG. 9 is a functional block diagram illustrating functional configurations of the coin change machine and the bill change machine;

FIG. 10 is a flowchart illustrating a flow of control processing for the coin change machine;

FIG. 11 is a flowchart illustrating a flow of control processing for operator determination in the coin change machine;

FIG. 12 is a flowchart illustrating a flow of control processing for the bill change machine;

FIG. 13 is a flowchart illustrating a flow of control processing for operator determination in the bill change machine;

FIG. 14 is a block diagram illustrating a hardware configuration of a self-service POS terminal according to other embodiment;

FIG. 15 is a block diagram illustrating a hardware configuration of a coin change machine according to the other embodiment;

FIG. 16 is a block diagram illustrating a hardware configuration of a bill change machine according to the other embodiment;

FIG. 17 is a flowchart illustrating a flow of control processing for a self-service POS terminal according to the other embodiment;

FIG. 18 is a flowchart illustrating a flow of control processing for operator determination in the self-service POS terminal;

FIG. 19 is a flowchart illustrating a flow of control processing for the coin change machine; and

FIG. 20 is a flowchart illustrating a flow of control processing for the bill change machine.

### DETAILED DESCRIPTION

An aspect of embodiments is to provide a change machine that limits the number of coins or bills if a customer deposits coins or bills exceeding a limit number and does not limit the number of coins or bills if a store staff member deposits coins or bills exceeding the limit number.

In general, a change machine according to one embodiment is a change machine to which coins or bills relating to purchase of a commodity are deposited, the change machine including: a denomination discriminating unit configured to discriminate denominations of the deposited coins or bills; a counting unit configured to count a number of the coins or the bills for each of the discriminated denominations; a storage unit configured to store a limit number of the coins or the bills; a number determining unit configured to determine a denomination of the coins or the bills, the number of which counted in one transaction by the counting unit reached the limit number; an operator determining unit configured to determine which of a customer and a store staff member deposited the coins or the bills; and a deposit control unit configured to, if the operator determining unit determines that the customer deposited the coins or the bills, return the coins or the bills of the denomination after reaching the limit number and, if the operator determining unit determines that the store staff member deposited the coins or the bills, allows storage of the coins or the bills of the denomination after reaching the limit number.

A change machine and a checkout device according to an embodiment are explained with reference to the accompanying drawings. In the embodiment, a self-service POS (Point of Sales) terminal in which a customer himself or herself executes commodity sales operation and settlement operation is explained as an example of the checkout device. In the embodiment, a coin change machine and a bill change machine are explained as examples of the change machine. Note that embodiments are not limited by the embodiment explained below.

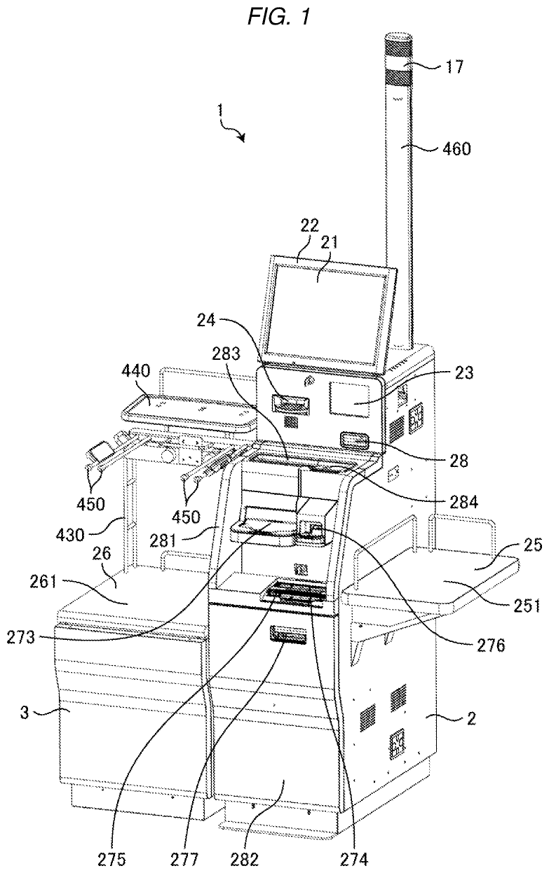

FIG. 1 is a perspective view illustrating an exterior of a self-service POS terminal 1 according to the embodiment. The self-service POS terminal 1 is a commodity sales data processing device including a registering unit that reads a code symbol such as a barcode attached to a commodity to be purchased and performs commodity registration processing and a checkout unit that performs checkout processing based on commodity information of the commodity subjected to the commodity registration processing. The customer himself or herself performs both of commodity registration operation and checkout operation in the self-service POS terminal 1. The commodity registration operation means operation for optically reading a code symbol or operation for imaging the code symbol. The checkout operation is operation for the self-service POS terminal 1 to perform the checkout processing for the commodity for which the commodity registration operation was performed.

The self-service POS terminal 1 executes the commodity registration processing based on the commodity registration operation performed by the customer. The self-service POS terminal 1 executes the checkout processing based on the checkout operation performed by the customer.

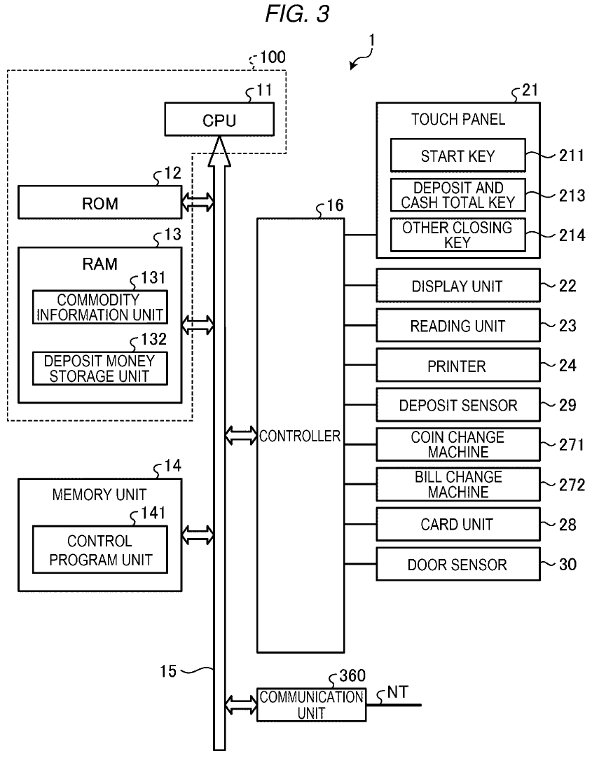

The commodity registration processing means processing for displaying, based on a commodity code acquired by the read code symbol, commodity information such as a commodity name and a price of the commodity and storing the commodity information in a commodity information unit 131 (see FIG. 3). The checkout processing means processing for displaying, based on the commodity information of the commodity subjected to the commodity registration processing, a total amount and a change amount relating to a transaction with the customer and performing settlement.

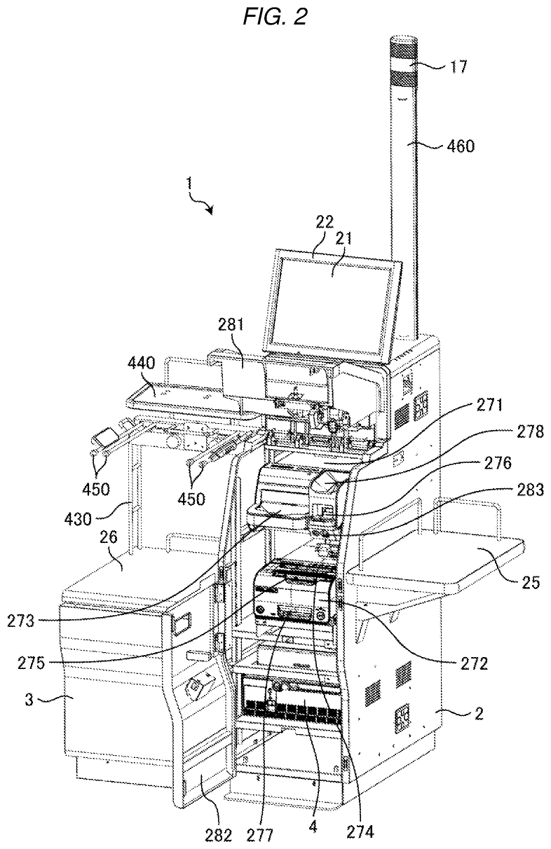

As illustrated in FIG. 1, the self-service POS terminal 1 includes a main body 2 and a bagging unit 3. The main body 2 includes, on the inside, a coin change machine 271 (see FIG. 2) and a bill change machine 272 (see FIG. 2). The coin change machine 271 receives coins deposited to the main body 2 by the customer and stores the coins for each of denominations. The coin change machine 271 dispenses coins serving as change to the customer using the stored coins. If coins are deposited, the coin change machine 271 discriminates denominations of the deposited coins and counts a total amount and the number for each of the denominations of the deposited coins in one transaction. The coin change machine 271 outputs information concerning the total amount and the number for each of the denominations of the coins deposited and stored in the storing unit to the self-service POS terminal 1 as deposit money information.

The main body 2 includes a coin placing section 283 and a depositing port 284 in an upper part. The coin placing section 283 is a region where coins to be deposited to the depositing port 284 are placed. For example, the customer takes out coins from a purse to the coin placing section 283. The depositing port 284 is a coin depositing port for depositing the coins taken out to the coin placing section 283 to the coin change machine 271 via the inside of the main body 2.

The main body 2 includes a coin tray 273 below the coin placing section 283 and the depositing port 284. The coin tray 273 is a receiving section for receiving coins dispensed as change from the coin change machine 271. The coin tray 273 is a part of a configuration of the coin change machine 271 and project to the outside from the main body 2.

The main body 2 includes a coin reject unit 276 near the coin tray 273 below the coin placing section 283 and the depositing port 284. The coin reject unit 276 is a discharge port for discharging, to the outside, heterogeneous coins (for example, foreign coins, false coins, and deformed coins) deposited to the coin change machine 271. The coin reject unit 276 is a part of the configuration of the coin change machine 271 and projects to the outside from the main body 2.

The coin change machine 271 sets a limit number (an upper limit number) for each of denominations for the number of coins deposited in one transaction. For a denomination deposited exceeding the limit number, an exceeding number of coins are dispensed to the coin reject unit 276 and the coins are returned.

The coin change machine 271 determines whether to apply the limit number and dispense the exceeding number of coins. Specifically, the coin change machine 271 determines whether a person who deposited coins to the coin change machine 271 (that is, a person operating the self-service POS terminal 1) is a customer or a store staff member (the store staff member means a person involved in management and operation of the store, for example, a store manager, a store responsible person, a store administrator, or a store clerk). If the person who deposited the coins to the coin change machine 271 is the customer, the coin change machine 271 applies the limit number and returns the number of coins exceeding the limit number. If the person who deposited the coins to the coin change machine 271 is the store staff member, the coin change machine 271 does not apply the limit number and receives all the deposited coins.

The bill change machine 272 receives bills deposited by the customer and stores the bills for each of denominations. The bill change machine 272 dispenses bills serving as change to the customer using the stored bills. If bills are deposited, the bill change machine 272 discriminates denominations of the deposited bills and counts a total amount and the number for each of the denominations of the deposited bills in one transaction. The bill change machine 272 outputs information concerning the total amount and the number for each of the denominations of the bills deposited and stored in the storing unit to the self-service POS terminal 1 as deposit money information.

The main body 2 includes a bill receiving port 274 and a bill dispensing port 275 below the coin tray 273 and the coin reject unit 276. The bill receiving port 274 is a slit-like depositing port to which bills are deposited. The bills deposited to the bill receiving port 274 are received in the bill change machine 272. The bill dispensing port 275 is a slit-like bill dispensing port from which the bills are dispensed as change. The bill receiving port 274 and the bill dispensing port 275 are provided near and substantially in parallel. The main body 2 includes a bill reject unit 277 below the bill receiving port 274 and the bill dispensing port 275. The bill reject unit 277 is a discharge port for discharging, to the outside, heterogeneous bills (for example, foreign bills and false bills) deposited to the bill change machine 272. The bill receiving port 274, the bill dispensing port 275, and the bill reject unit 277 are parts of the configuration of the bill change machine 272 and project to the outside from the main body 2.

The bill change machine 272 sets a limit number (an upper limit number) for each of denominations for the number of bills deposited in one transaction. For a denomination deposited exceeding the limit number, an exceeding number of bills are dispensed to the bill reject unit 277 and the bills are returned.

The bill change machine 272 determines whether to apply the limit number and dispense the exceeding number of bills. Specifically, the bill change machine 272 determines whether a person who deposited bills to the bill change machine 272 (that is, a person operating the self-service POS terminal 1) is the customer or the store staff member. If the person who deposited the bills to the bill change machine 272 is the customer, the bill change machine 272 applies the limit number and dispenses the number of bills exceeding the limit number. If the person who deposited the bills to the bill change machine 272 is the store staff member, the bill change machine 272 does not apply the limit number and receives all the deposited bills.

The main body 2 includes a door 281 and a door 282 capable of opening and closing. The door 281 turns in the up-down direction. The door 282 turns in the left-right direction (see FIG. 2). The door 282 is interfered by the door 281. To open the door 282, first, the door 281 needs to be opened in the upward direction. If both of the door 281 and the door 282 are in a closed state, only the door 282 cannot be opened. The door 281 turns upward to open the inside of the main body 2 and the door 282 turns in the left-right direction to open the inside of the main body 2, whereby the inner upper side of the main body 2 is opened and the coin change machine 271 and the bill change machine 272 are exposed.

The main body 2 includes a placing table 25 on the side surface right side. The placing table 25 is a table for placing a basket including commodities to be purchased.

A reading unit 23, a printer 24, and a card unit 28 are housed in an upper part of the main body 2. For example, the reading unit 23 optically reads or images a code symbol such as a barcode or a two-dimensional code attached to a commodity. The card unit 28 reads customer specifying information from an inserted credit card. If settlement is performed with the credit card, the self-service POS terminal 1 executes settlement processing based on the customer specifying information read by the card unit 28. The printer 24 prints commodity information and checkout information of a commodity subjected to commodity registration processing by the self-service POS terminal 1 on receipt paper and dispenses a receipt.

The self-service POS terminal 1 includes a display unit 22 in an upper part of the main body 2. The display unit 22 displays commodity information of a commodity subjected to commodity registration processing involved in commodity registration operation by the customer. The display unit 22 displays checkout information in the case in which checkout processing involved in checkout operation by the customer was performed. The display unit 22 includes a touch panel 21 on the surface. The touch panel 21 plays a role of a key. By touching the touch panel 21 in positions corresponding to various kyes displayed on the display unit 22, the keys are operated.

The self-service POS terminal 1 includes, in an upper surface rear part of the main body 2, a columnar pole 460 extending upward from the upper surface. The self-service POS terminal 1 includes a light emitting unit 17 at the upper distal end portion of the pole 460. The light emitting unit 17 emits light if an error occurred in the self-service POS terminal 1 or if the customer performed operation for calling an attendant.

The self-service POS terminal 1 includes a bagging unit 3 on the left side of the main body 2 (the opposite side of the placing table 25 in the left-right direction). The bagging unit 3 is a device that performs bagging for commodities for which commodity registration processing ended.

The bagging unit 3 includes two columns 430 extending upward from the upper surface of the placing table 26 and a temporary placing table 440 and two pairs of extending bars 450 formed in upper parts of the columns 430. The extending bars 450 are bars for setting a bag (not illustrated) in which commodities, commodity codes of which were read by the reading unit 23 (see FIG. 3), are put. The bag is opened with a grip of the bag hung on the extending bars 450 to make it easy to put the commodities, the commodity codes of which were read, in the bag. The temporary placing table 440 is a table on which fragile commodities (for example, tofu and eggs) among the commodities, the commodity codes of which were read by the reading unit 23, are temporarily placed. The commodities placed on the temporary placing table 440 are finally put in the bag.

The customer takes out a commodity from the basket placed on the placing table 25, causes the commodity to pass the front of the reading unit 23, and performs commodity registration operation for causing the reading unit 23 to read a code symbol attached to the commodity. The customer puts the commodity, the commodity symbol of which was read, in the bag placed on the placing table 26. The self-service POS terminal 1 executes commodity registration processing for the commodity for which the commodity registration operation was performed.

The customer who performed the commodity registration operation for all the commodities to be purchased performs checkout operation next. For example, as the checkout operation, if making payment by cash, the customer operates a deposit and cash total key 213 (see FIG. 3). If making payment by a medium other than cash, the customer operates an other closing key 214 (for example, a credit key or an electronic money key; see FIG. 3).

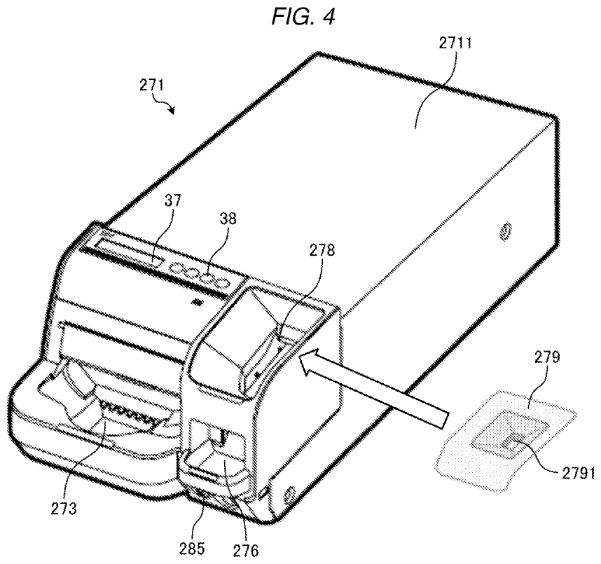

If making payment by cash, the customer places coins of the cash on the coin placing section 283 and slides the coins with a finger to deposit the coins to the depositing port 284. The coins deposited to the depositing port 284 are guided to the coin change machine 271, deposited to a receiving port 278 (see FIG. 4), and received on the inside of the coin change machine 271.

If making payment by cash, the customer deposits bills of the cash to the bill receiving port 274. The bills deposited to the bill receiving port 274 is received in the bill change machine 272.

FIG. 2 is a perspective view illustrating an exterior of the self-service POS terminal 1 in which the door 281 and the door 282 are opened. In this state, the coin change machine 271 and the bill change machine 272 are exposed to the outside. On the inside of the main body 2, the coin change machine 271 is disposed above the bill change machine 272.

The store staff member opens the door 281 and the door 282, supplies coins to the coin change machine 271, and collects coins from the coin change machine 271. The store staff member opens the door 281 and the door 282, supplies bills to the bill change machine 272, and collects bills from the bill change machine 272. For example, the store staff member supplies coins and bills as change reserve money. For example, if coins and bills stored in the coin change machine 271 and the bill change machine 272 overflowed, the store staff member collects the coins and the bills.

The coin change machine 271 includes a receiving port 278 in an upper part. The receiving port 278 is a depositing port for depositing coins to the inside of the coin change machine 271. The coins deposited to the depositing port 284 are conveyed through a not-illustrated path and deposited to the receiving port 278. If supplying coins to the coin change machine 271, rather than depositing the coins to the depositing port 284, the store staff member opens the door 281 and the door 282 and directly deposits the coins to the receiving port 278 exposed to the outside by opening the door 281. If supplying bills to the bill change machine 272, the store staff member deposits the bills to the bill receiving port 274.

Note that a power supply unit 4 is disposed below the bill change machine 272. The power supply unit 4 includes a circuit unit and a control unit 100 (see FIG. 3) for controlling the self-service POS terminal 1.

Subsequently, a hardware configuration of the self-service POS terminal 1 is explained. FIG. 3 is a block diagram illustrating a hardware configuration of the self-service POS terminal 1. As illustrated in FIG. 3, the self-service POS terminal 1 includes a CPU (Central Processing Unit) 11, a ROM (Read Only Memory) 12, a RAM (Random Access Memory) 13, a memory unit 14, and the like. The CPU 11 is an example of a processor and is a control entity. The ROM 12 stores various programs. Various data are loaded in the RAM 13. The memory unit 14 stores various programs. The CPU 11, the ROM 12, the RAM 13, and the memory unit 14 are connected to one another via a data bus 15. The CPU 11, the ROM 12, and the RAM 13 configure the control unit 100. That is, the CPU 11 operates according to a control program stored in the ROM 12 or the memory unit 14 and loaded in the RAM 13, whereby the control unit 100 executes control processing for the self-service POS terminal 1 explained below.

The RAM 13 includes a commodity information unit 131 and a deposit money storage unit 132. The commodity information unit 131 stores commodity information (a commodity code, a commodity name, a price, and the like) of a commodity subjected to commodity registration processing. The deposit money storage unit 132 receives deposit money information of an amount of coins stored in the coin change machine 271 and an amount of bills stored in the bill change machine 272 in one transaction respectively from the coin change machine 271 and the bill change machine 272 and stores the deposit money information of the bills.

The memory unit 14 is configured by a nonvolatile memory such as an HDD (Hard Disk Drive) or a flash memory in which stored information is retained even if power is turned off and includes a control program unit 141 that stores a control program.

The control unit 100 is communicably connected to the touch panel 21, the display unit 22, the reading unit 23, the printer 24, a deposit sensor 29, the coin change machine 271, the bill change machine 272, the card unit 28, and a door sensor 30 via the data bus 15 and a controller 16.

The touch panel 21 includes keys such as a start key 211, the deposit and cash total key 213, and the other closing key 214. The customer operates the start key 211 if starting sales registration operation for a commodity. The customer operates the deposit and cash total key 213 if ending the commodity registration operation for the commodity and shifting to checkout processing for making payment by cash. If the deposit and cash total key 213 is operated, the self-service POS terminal 1 starts checkout processing by cash. The customer operates the other closing key 214 if ending the commodity registration operation for the commodity and shifting to checkout processing for making payment by a medium other than cash. If the other closing key 214 is operated, the self-service POS terminal 1 starts checkout processing by an operated medium other than cash.

The display unit 22 is formed by, for example, LCD (Liquid Crystal Display) and displays information to the customer. The reading unit 23 is configured by, for example, a camera and reads a code symbol attached to a commodity. The printer 24 is configured by, for example, a thermal printer and prints commodity information and checkout information of a commodity subjected to checkout processing and dispenses a receipt. The card unit 28 reads information from, for example, a credit card.

The deposit sensor 29 is a sensor that detects that coins were deposited to the depositing port 284. If coins are deposited to the depositing port 284, the deposit sensor 29 performs output indicating that the coins were deposited to the depositing port 284. The door sensor 30 is a sensor that detects whether the door 281 and the door 282 are opened or closed. If the door 281 and the door 282 are opened, the door sensor 30 performs output indicating that the door 281 and the door 282 are opened. If the door 281 and the door 282 are closed, the door sensor 30 performs output indicating that the door 281 and the door 282 are closed.

The control unit 100 is connected to the communication unit 360 via the data bus 15. The communication unit 360 is connected to other self-service POS terminals 1, a store server (not illustrated), and the like via a communication line NT.

FIG. 4 is a perspective view illustrating an exterior of the coin change machine 271 incorporated in the main body 2. The coin change machine 271 includes a coin storing unit (not illustrated) in a housing 2711. The coin storing unit stores, for each of denominations, coins deposited to the receiving port 278. If coins are dispensed as change, the coins stored in the coin storing unit are dispensed to the coin tray 273.

In the coin change machine 271, a cover 279 can be attached to an upper part of the receiving port 278 to cover the receiving port 278 from above. The cover 279 includes a hole 2791 substantially in the center. The hole 2791 is a hole that has an elongated shape through which a small number of coins (for example, one coin) can pass and limits the number of coins dropping to the receiving port 278 (limits the number of coins deposited from the depositing port 284 and dropping to the receiving port 278). If the customer operates the self-service POS terminal 1, the cover 279 is attached to the receiving port 278. If the cover 279 is attached to the receiving port 278, since coins deposited to the receiving port 278 are suppressed, it is possible to prevent a coin jam in the receiving port 278. If the store staff member supplies coins to the coin change machine 271, the store staff member supplies the coins without attaching (by removing) the cover 279.

Note that an example of the attaching the cover 279 to the receiving port 278 and removing the cover 279 from the receiving port 278 is physically attaching the cover 279 to the receiving port 278 and physically removing the cover 279 from the receiving port 278. Another example of the attaching the cover 279 to the receiving port 278 and removing the cover 279 from the receiving port 278 may be enabling the cover 279 to be opened and closed with respect to the receiving port 278 in a state in which the cover 279 is attached to the receiving port 278, attaching the cover 279 to the receiving port 278 if the cover 279 attached to the receiving port 278 is closed with respect to the receiving port 278, and removing the cover 279 from the receiving port 278 if the cover 279 attached to the receiving port 278 is opened with respect to the receiving port 278.

The coin change machine 271 includes a display unit 37 and an operation unit 38 (a button operation unit). The display unit 37 displays information to the store staff member who operates the coin change machine 271. For example, if the store staff member supplies coins, the store staff member operates the operation unit 38 to cause the coin change machine 271 to function not to perform control relating to a number limit set in the coin change machine 271.

The coin change machine 271 includes, below the coin reject unit 276, a key hole 285 (a key operation section) for inserting a key. The key can be inserted into the key hole 285 and turned to a plurality of positions. The key is turned to predetermined positions to switch the coin change machine 271 to various modes (including, for example, a normal mode for performing storage of coins and dispensing of change, a deposit mode for supplying coins, and collection mode for collecting coins).

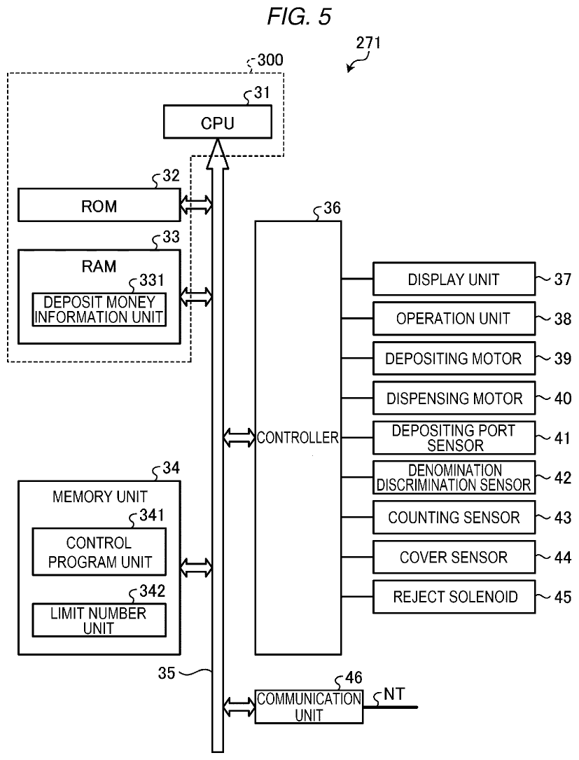

FIG. 5 is a block diagram illustrating a hardware configuration of the coin change machine 271. In FIG. 5, the coin change machine 271 includes a CPU 31, a ROM 32, a RAM 33, a memory unit 34, and the like. The CPU 31 is an example of a processor and is a control entity. The ROM 32 stores various programs. Various data are loaded in the RAM 33. The memory unit 34 stores various programs. The CPU 31, the ROM 32, the RAM 33, and the memory unit 34 are connected to one another via a data bus 35. The CPU 31, the ROM 32, and the RAM 33 configure a control unit 300. That is, the CPU 31 operates according to a control program stored in the ROM 32 or the memory unit 34 and loaded in the RAM 33, whereby the control unit 300 executes control processing for the coin change machine 271 explained blow.

The RAM 33 includes a deposit money information unit 331. The deposit money information unit 331 stores, in one transaction, in the coin change machine 271, for each of denominations, the numbers of coins stored in a coin storing unit.

The memory unit 34 is configured by a nonvolatile memory such as an HDD or a flash memory in which stored information is retained even if power is turned off and includes a control program unit 341 that stores a control program and a limit number unit 342. The limit number unit 342 stores limit numbers of coins for each of denominations. The limit numbers are upper limit numbers of coins that can be deposited to the coin change machine 271 in one transaction. Note that, as the limit numbers, the same number may be stored for all denominations or different limit numbers may be stored for each of the denominations. One number common to all the denominations may be stored. The limit numbers can be set and the set numbers can be changed. The setting and the change of the limit numbers are performed using the operation unit 38 or are performed by receiving a command for setting the numbers of coins for each of denominations from the self-service POS terminal 1. If the customer operates the self-service POS terminal 1 (that is, if the customer deposits coins from the depositing port 284), the customer cannot deposit coins of the same denomination exceeding the limit number.

The control unit 300 is connected to the display unit 37, the operation unit 38, a depositing motor 39, a dispensing motor 40, a receiving port sensor 41, a denomination discrimination sensor 42, a counting sensor 43, a cover sensor 44, and a reject solenoid 45 via a data bus 35 and a controller 36. The depositing motor 39 is a motor for conveying and receiving coins deposited to the receiving port 278 and storing the coins in the coin storing unit. The dispensing motor 40 is a motor for conveying coins stored in the coin storing unit and dispensing the coins to the coin tray 273. The receiving port sensor 41 is a sensor that detects coins deposited to the receiving port 278. If coins were deposited to the receiving port 278, the receiving port sensor 41 performs output indicating that the coins were deposited. The denomination discrimination sensor 42 is a sensor that detects, for example, materials, sizes, and thicknesses of deposited coins to discriminate authenticity of the coins, heterogeneous coins, presence or absence of deformation, and denominations. The counting sensor 43 is a sensor that detects, for each of denominations, the numbers of coins dropping to the coin storing unit. It is possible to count the number of coins received in the coin change machine 271 (bills stored in the coin storing unit) in one transaction by counting the number of coins detected by the counting sensor 43.

The cover sensor 44 is a sensor that detects whether the cover 279 is attached to the receiving port 278. If the denomination discrimination sensor 42 detected heterogeneous coins, false coins, or deformed coins, the reject solenoid 45 operates to drop the coins to sort the coins. The reject solenoid 45 operates to drop coins of a denomination exceeding the limit number to sort the coins. The coins sorted by the reject solenoid 45 are discharged to the coin reject unit 276 (returned).

The control unit 300 is connected to a communication unit 46 via the data bus 35. The communication unit 46 is connected to the controller 16 of the self-service POS terminal 1 via a communication cable NC.

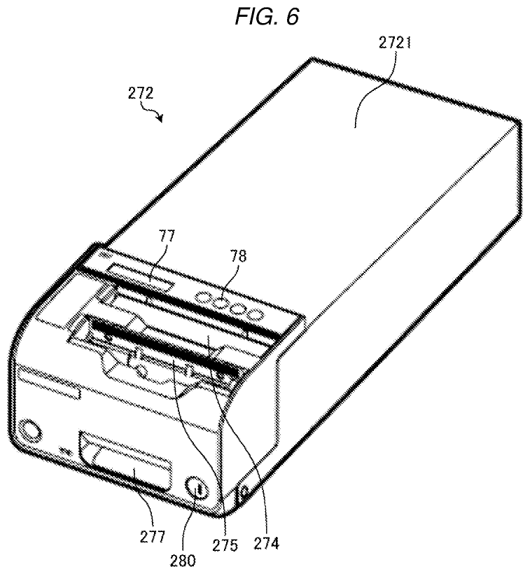

FIG. 6 is a perspective view illustrating an exterior of the bill change machine 272 incorporated in the main body 2. The bill change machine 272 includes a bill storing unit (not illustrated) in a housing 2721. The bill storing unit stores, for each of denominations, bills deposited to the bill receiving port 274. If paying a price, the customer deposits bills to the bill receiving port 274. If supplying bills to the bill change machine 272, the store staff member deposits, to the bill receiving port 274, the bills to be supplied. If dispensing bills as change, the bill change machine 272 dispenses the bills stored in the bill storing unit to the bill dispensing port 275.

The bill change machine 272 includes a display unit 77 and an operation unit 78 (a button operation unit). The display unit 77 displays information to the store staff member who operates the bill change machine 272. For example, if the store staff member supplies bills, the store staff member operates the operation unit 78 to cause the bill change machine 272 to function not to perform control relating to a limit number set in the bill change machine 272.

The bill change machine 272 includes, on a lateral side of the bill reject unit 277, a key hole 280 for inserting a key. The key can be inserted into the key hole 280 and turned to a plurality of positions. The key is turned to predetermined positions to switch the bill change machine 272 to various modes (including, for example, a normal mode for performing storage of bills and dispensing of change, a deposit mode for supplying bills, and collection mode for collecting bills).

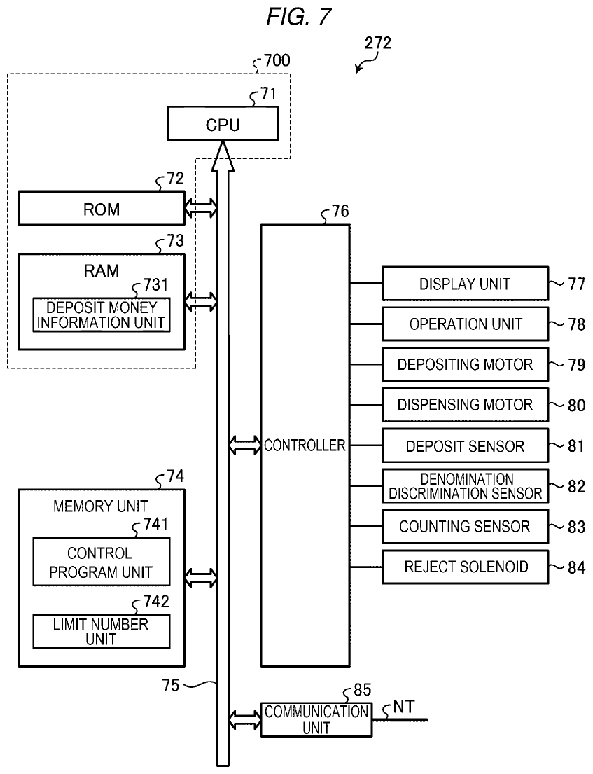

FIG. 7 is a block diagram illustrating a hardware configuration of the bill change machine 272. In FIG. 7, the bill change machine 272 includes a CPU 71, a ROM 72, a RAM 73, a memory unit 74, and the like. The CPU 71 is an example of a processor and is a control entity. The ROM 72 stores various programs. Various data are loaded in the RAM 73. The memory unit 74 stores various programs. The CPU 71, the ROM 72, the RAM 73, and the memory unit 74 are connected to one another via a data bus 75. The CPU 71, the ROM 72, and the RAM 73 configure a control unit 700. That is, the CPU 71 operates according to a control program stored in the ROM 72 or the memory unit 74 and loaded in the RAM 73, whereby the control unit 700 executes control processing for the bill change machine 272 explained below.

The RAM 73 includes a deposit money information unit 731. The deposit money information unit 731 stores, for each of denominations, the numbers of bills stored in the bill change machine 272 in one transaction.

The memory unit 74 is configured by a nonvolatile memory such as an HDD or a flash memory in which stored information is retained even if power is turned off and includes a control program unit 741 that stores a control program and a limit number unit 742. The limit number unit 742 stores limit numbers of bills for each of denominations. The limit numbers are upper limit numbers of bills that can be deposited to the bill change machine 272 in one transaction. The limit numbers may be the same number for all the denominations or may be different for each of the denominations. The limit numbers can be set and can be changed. The setting and the change of the limit numbers are performed using the operation unit 78 or are performed by receiving a command for setting the numbers of bills for each of denominations from the self-service POS terminal 1. If the customer operates the self-service POS terminal 1 (that is, if the customer deposited bills from the bill receiving port 274), the customer cannot deposit bills of the same denomination exceeding the limit number.

The control unit 700 is connected to the display unit 77, the operation unit 78, a depositing motor 79, a dispensing motor 80, a receiving sensor 81, a denomination discrimination sensor 82, a counting sensor 83, and a reject solenoid 84 via the data bus 75 and a controller 76. The depositing motor 79 is a motor for conveying and receiving bills deposited to the bill receiving port 274 and storing the bills in the bill storing unit. The dispensing motor 80 is a motor for conveying the bills stored in the bill storing unit and dispensing the bills to the bill dispensing port 275. The denomination discrimination sensor 82 is a sensor that detects, for example, materials and sizes of deposited bills to discriminate authenticity, heterogeneous bills, and denominations of the bills. The counting sensor 83 is a sensor that detects, for each of denominations, the numbers of bills stored in the bill storing unit. The counting sensor 83 can count the number of bills deposited to the bill change machine 272 in one transaction (bills stored in the bill storing unit) by counting the number of bills detected by the counting sensor 83.

If the denomination discrimination sensor 82 detected deposit of heterogeneous bills or false fills, the reject solenoid 84 operates to sort the bills. The reject solenoid 84 operates to sort bills of a denomination exceeding the limit number. The bills sorted by the reject solenoid 84 are discharged to the bill reject unit 277 (returned).

The control unit 700 is connected to a communication unit 85 via the data bus 75. The communication unit 85 is connected to the controller 16 of the self-service POS terminal 1 via the communication cable NC.

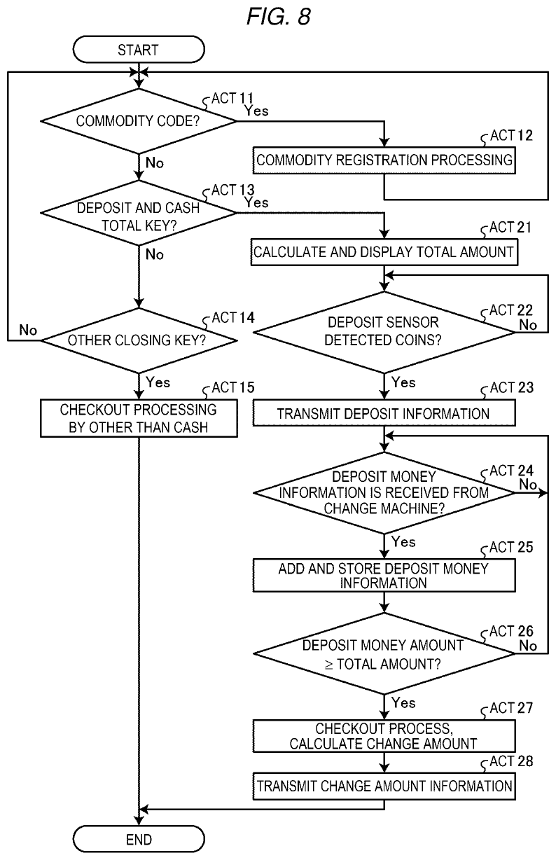

Control for the self-service POS terminal 1 is explained below. FIG. 8 is a flowchart illustrating a flow of control processing for the self-service POS terminal 1. As illustrated in FIG. 8, the control unit 100 of the self-service POS terminal 1 determines whether a code symbol attached to a commodity was read and a commodity code for specifying the commodity was acquired (Act 11). If determining that the commodity code was acquired (Yes in Act 11), the control unit 100 executes commodity registration processing for the commodity based on the acquired commodity code (Act 12). The control unit 100 returns to Act 11. If determining that the commodity code was not acquired (No in Act 11), the control unit 100 determines whether the deposit and cash total key 213 was operated (Act 13). If determining that the deposit and cash total key 213 was not operated (No in Act 13), the control unit 100 determines whether the other closing key 214 was operated (Act 14).

If determining that the other closing key 214 was not operated (No in Act 14), the control unit 100 returns to Act 11. If determining that the other closing key 214 was operated (Yes in Act 14), the control unit 100 executes checkout processing using a medium other than cash (Act 15). For example, the control unit 100 executes the checkout processing based on a credit card inserted into the card unit 28 or an electronic money card held over the card unit 28. The control unit 100 ends the processing.

If determining that the deposit and cash total key 213 was operated (Yes in Act 13), the control unit 100 calculates a total amount (including a tax) of the commodity sold in the transaction, stores the total amount in the commodity information unit 131, and displays the total amount on the display unit 22 (Act 21).

Subsequently, the control unit 100 determines whether the deposit sensor 29 detected depositing of coins to the depositing port 284 (Act 22). The control unit 100 stays on standby until the deposit sensor 29 detects depositing of coins (No in Act 22). If determining that the deposit sensor 29 detected depositing of coins (Yes in Act 22), the control unit 100 transmits, to the coin change machine 271, deposit information indicating that the coins were deposited to the depositing port 284 (Act 23).

Subsequently, the control unit 100 determines whether deposit money information received from the coin change machine 271 and the bill change machine 272 were received (Act 24). The deposit money information received from the coin change machine 271 is an amount of coins deposited to the coin change machine 271 in one transaction (which is an amount of deposit money in coins and is a total amount of coins stored in the coin storing unit of the coin change machine 271 excluding a refunded amount explained below). The deposit money information received from the bill change machine 272 is an amount of bills deposited to the bill change machine 272 in one transaction (which is an amount of deposit money in bills and is a total amount of bills stored in the bill storing unit of the bill change machine 272 excluding a refunded amount explained below).

The control unit 100 stays on standby until determining that the deposit money information was received (No in Act 24). If determining that the deposit money information was received from the coin change machine 271 and the bill change machine 272 (Yes in Act 24), the control unit 100 stores the received deposit money information in the deposit money storage unit 132 (Act 25). Note that, if receiving the deposit money information a plurality of times, the control unit 100 accumulates and stores the deposit money information every time the deposit money information is received in Act 25.

Subsequently, the control unit 100 compares the total amount information calculated in Act 21 and the stored deposit money information and determines whether the amount of the deposit money is equal to or more than the total amount (Act 26). If determining that the amount of the deposit money is less than the total amount (No in Act 26), the control unit 100 returns to Act 24. If determining that the amount of the deposit money is equal to or more than the total amount (Yes in Act 26), the control unit 100 executes checkout processing relating to the transaction based on the deposit money stored in the deposit money storage unit 132 and the total amount stored in the commodity information unit 131 (Act 27). The control unit 100 calculates a change amount if the amount of the deposit money is more than the total amount (Act 27). The control unit 100 transmits information concerning a change amount to be dispensed in coins in the calculated change amount to the coin change machine 271 (Act 28) and transmits information concerning a change amount to be dispensed in bills in the calculated change amount to the bill change machine 272 (Act 28). The control unit 100 ends the processing.

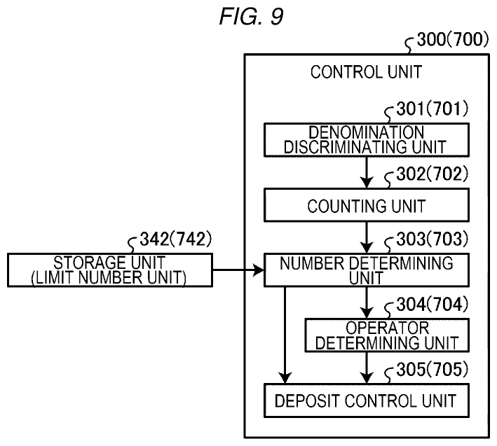

A functional configuration of the coin change machine 271 is explained below. FIG. 9 is a functional block diagram illustrating the functional configuration of the coin change machine 271. The control unit 300 of the coin change machine 271 follows the control program stored in the ROM 32 or the control program unit 341 of the memory unit 34 to function as a denomination discriminating unit 301, a counting unit 302, a number determining unit 303, an operator determining unit 304, and a deposit control unit 305.

The denomination discriminating unit 301 discriminates denominations of deposited coins. In the embodiment, the denomination discriminating unit 301 discriminates denominations of deposited coins based on output from the denomination discrimination sensor 42 that is based on materials, sizes, and the like of coins passing through the denomination discrimination sensor 42.

The counting unit 302 counts the numbers of the coins for each of the discriminated denominations. In the embodiment, the counting unit 302 counts, as the numbers of the coins, the numbers of times the counting sensor 43 detected, for each of the denominations, coins dropping to the coin storing unit.

The number determining unit 303 determines a denomination, the number of coins of which counted by the counting unit 302 reached a limit number. In the embodiment, the number determining unit 303 compares the numbers of coins for each of the denominations counted by the counting unit 302 and the limit numbers for each of the denominations stored in the limit number unit 342 and determines a denomination, the number of coins of which reached a limit number. Specifically, the number determining unit 303 compares, about the coins of the denominations discriminated by the denomination discriminating unit 301, the numbers counted by the counting unit 302 and the limit numbers for each of the denominations stored in the limit number unit 342 and determines whether the numbers reached the limit numbers.

The operator determining unit 304 determines which of the customer and the store staff member deposited coins to the coin change machine 271 (that is, which of the customer and the store staff member is operating the self-service POS terminal 1). In the embodiment, for example, in any one of the following cases, the operator determining unit 304 determines that the store staff member deposited the coins.

(1) If the position of the key inserted into the key hole 285 is the position of the deposit mode, the operator determining unit 304 determines that the store staff member deposited the coins.

(2) If operation for changing the coin change machine 271 to the deposit mode was performed in the operation unit 38, the operator determining unit 304 determines that the store staff member deposited the coins.

(3) If the cover 279 is not attached to the receiving port 278, the operator determining unit 304 determines that the store staff member deposited the coins.

(4) If a command for supplying coins was received from the self-service POS terminal 1 connected to the coin change machine 271, the operator determining unit 304 determines that the store staff member deposited the coins.

(5) If deposit information indicating that coins were deposited to the self-service POS terminal 1 was not received from the self-service POS terminal 1 connected to the coin change machine 271 and coins were deposited to the receiving port 278, the operator determining unit 304 determines that the store staff member deposited the coins.

If determining that none of the above (1) to (5) is satisfied, the operator determining unit 304 determines that the customer deposited the coins.

Note that, although details are not explained, for example, if the door sensor 30 detected that one or both of the door 281 and the door 282 are opened, the self-service POS terminal 1 may transmit opening information of the door 281 and the door 282 to the coin change machine 271. If receiving the opening information, the operator determining unit 304 may determine that the store staff member deposited the coins.

If the operator determining unit 304 determines that the customer deposited the coins, the deposit control unit 305 returns the coins of the denomination after reaching the limit number without storing the coins of the denomination in the coin storing unit. If the operator determining unit 304 determines that the store staff member deposited the coins, the deposit control unit 305 allows storage of the coins of the denomination after reaching the limit number in the coin storing unit. In the embodiment, if the operator determining unit 304 determines that the customer deposited the coins, the deposit control unit 305 drives the reject solenoid 45 and dispenses the coins of the denomination after reaching the limit number to the coin reject unit 276. If the operator determining unit 304 determines that the store staff member deposited the coins, the deposit control unit 305 continuously stores the coins of the denomination after reaching the limit number in the coin storing unit.

FIG. 9 is a functional block diagram illustrating a functional configuration of the bill change machine 272. A control unit 700 of the bill change machine 272 follows the control program stored in the ROM 72 or the control program unit 741 of the memory unit 74 to function as a denomination discriminating unit 701, a counting unit 702, a number determining unit 703, an operator determining unit 704, and a deposit control unit 705.

The denomination discriminating unit 701 discriminates denominations of deposited bills. In the embodiment, the denomination discriminating unit 701 discriminates denominations of deposited bills based on output from the denomination discrimination sensor 82 that is based on materials, sizes, and the like of bills passing through the denomination discrimination sensor 82.

The counting unit 702 counts the numbers of the bills for each of the discriminated denominations. In the embodiment, the counting unit 702 counts, as the numbers of the bills, the numbers of times the counting sensor 83 detected, for each of the denominations, bills stored in the bill storing unit.

The number unit determining 703 determines a denomination, the number of bills of which counted by the counting unit 702 exceeded a limit number. In the embodiment, the number determining unit 703 compares the numbers of bills for each of the denominations counted by the counting unit 702 and the limit numbers for each of the denominations stored in the limit number unit 742 and determines a denomination, the number of bills of which exceeded a limit number. Specifically, the number determining unit 703 compares, about the bills of the denomination discriminated by the denomination discriminating unit 701, the number counted by the counting unit 702 and the limit numbers for each of the denominations stored in the limit number unit 742 and determines whether the number reached the limit number.

The operator determining unit 704 determines which of the customer and the store staff member deposited bills to the bill change machine 272 (that is, which of the customer and the store staff member is operating the self-service POS terminal 1). In the embodiment, for example, in any one of the following cases, the operator determining unit 704 determines that the store staff member deposited the bills.

(6) If the position of the key inserted into the key hole 280 is the position of the deposit mode, the operator determining unit 704 determines that the store staff member deposited the bills.

(7) If operation for changing the bill change machine 272 to the deposit mode was performed in the operation unit 78, the operator determining unit 704 determines that the store staff member deposited the bills.

(8) If a command for supplying bills was received from the self-service POS terminal 1 connected to the bill change machine 272, the operator determining unit 704 determines that the store staff member deposited the bills.

If determining that none of the above (6) to (8) is satisfied, the operator determining unit 704 determines that the customer deposited the bills.

Although details are no explained, for example, if the door sensor 30 detected that one or both of the door 281 and the door 282 are opened, the self-service POS terminal 1 may transmit opening information of the door 281 and the door 282 to the bill change machine 272. If receiving the opening information, the operator determining unit 704 may determine that the store staff member deposited the bills.

If the operator determining unit 704 determines that the customer deposited the bills, the deposit control unit 705 returns the bills of the denomination after reaching the limit number. If the operator determining unit 704 determines that the store staff member deposited the bills, the deposit control unit 305 allows storage of the bills of the denomination after reaching the limit number in the bill storing unit. In the embodiment, if the operator determining unit 704 determines that the customer deposited the bills, the deposit control unit 705 drives the reject solenoid 84 and dispenses the bills of the denomination after reaching the limit number to the bill reject unit 277. If the operator determining unit 704 determines that the store staff member deposited the bills, the deposit control unit 705 continuously stores the bills of the denomination after reaching the limit number in the bill storing unit.

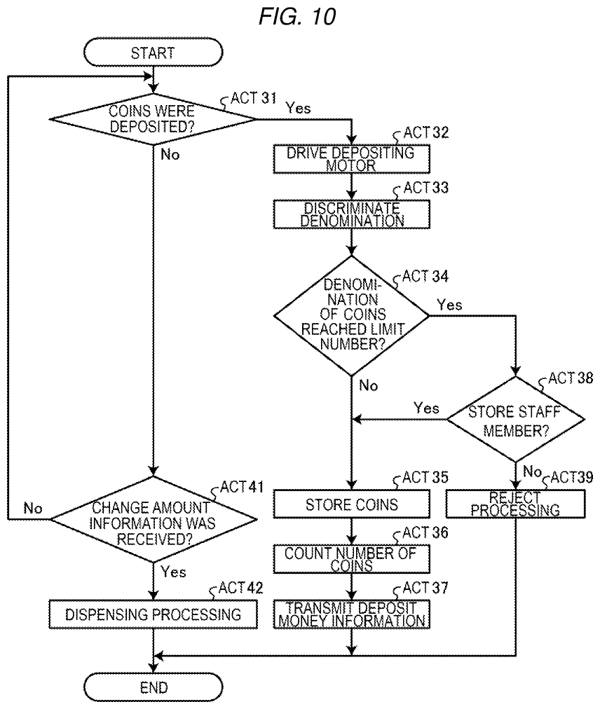

Subsequently, control for the coin change machine 271 is explained. FIG. 10 is a flowchart illustrating a flow of control processing for the coin change machine 271. As illustrated in FIG. 10, the control unit 300 of the coin change machine 271 determines whether coins were deposited to the receiving port 278 (Act 31). If the receiving port sensor 41 performed output indicating that coins were deposited to the receiving port 278, the control unit 300 determines that the coins were deposited to the receiving port 278. If determining that the coins were deposited to the receiving port 278 (Yes in Act 31), the control unit 300 drives the depositing motor 39 and carries the coins deposited to the receiving port 278 into the coin change machine 271 (Act 32).

Subsequently, the denomination discriminating unit 301 drives the denomination discrimination sensor 42 and determines a denomination of carried-in one coin (Act 33). Subsequently, the number determining unit 303 determines, about the coins of the denomination determined by the denomination discriminating unit 301, whether the number of counts of the coins stored in the deposit money information unit 331 reached the limit number stored in the limit number unit 342 (Act 34). If determining that the number of counts did not reach the limit number (No in Act 34), the control unit 300 stores the coins in the coin storing unit (Act 35). If the coins are stored in the coin storing unit, based on output indicating that the counting sensor 43 detected the coins, the counting unit 302 increments, by one, the number of counts of the coins of the denomination discriminated by the denomination discriminating unit 301 in the number of counts of the coins stored in the deposit money information unit 331 (Act 36). The control unit 300 transmits deposit money information including an amount and the number of the coins (one) stored in the coin storing unit to the self-service POS terminal 1 (Act 37). The control unit 300 ends the processing and returns to Act 21 and executes the same processing for a coin carried in next.

If determining that the number of counts reached the limit number (Yes in Act 34), the operator determining unit 304 determines which of the customer and the store staff member deposited the coins to the coin change machine 271 (that is, whether the operator of the self-service POS terminal 1 is the customer or the store staff member) (Act 38). If the operator determining unit 304 determines that the customer deposited the coins to the coin change machine 271 (No in Act 38), the deposit control unit 305 drives the reject solenoid 45, performs reject processing for dropping the carried-in coin and dispensing the coin to the coin reject unit 276, and returns the coin to the customer (Act 39). The control unit 300 ends the processing and returns to Act 21 and executes the same processing for a coin carried in next.

Note that, if the reject processing was performed, the control unit 300 desirably transmits message information indicating the return of the coin and a reason for the return (the number of paid coins of the denomination reached the limit number) to the self-service POS terminal 1 such that the self-service POS terminal 1 displays the message information. If the self-service POS terminal 1 displays the message, the customer can deposit another coin that is not the returned coin.

If the operator determining unit 304 determines that the store staff member deposited the coins to the coin change machine 271 (Yes in Act 38), the deposit control unit 305 executes the processing in Act 35 for storing the coins in the coin storing unit and, thereafter, executes the processing in Act 36 and Act 37. That is, the deposit control unit 305 stores the coins of the denomination in the coin storing unit even after the number of coins reached the limit number. The control unit 300 ends the processing and returns to Act 21 and executes the same processing for a coin carried in next.

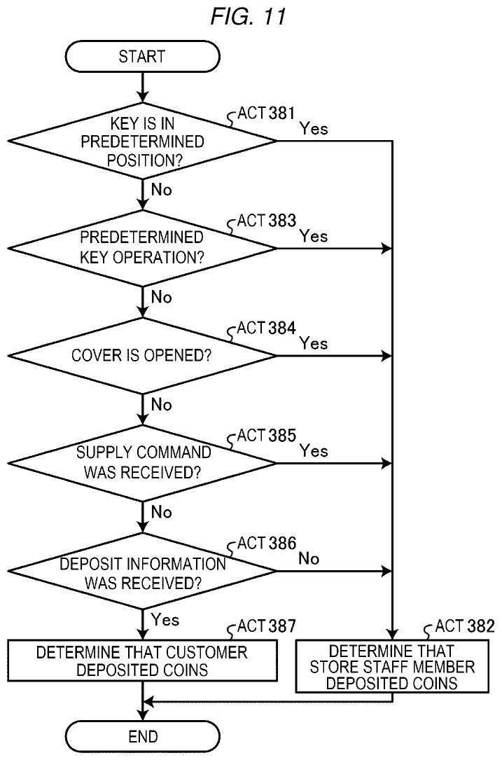

FIG. 11 is a flowchart illustrating a flow of control processing for operator determination in the coin change machine 271 executed in Act 38 by the operator determining unit 304. As illustrated in FIG. 11, the operator determining unit 304 determines whether the key is not inserted into the key hole 285 or is inserted and located in the predetermined position (Act 381). If the key is inserted and located in the predetermined position (the position of the deposit mode) (Yes in Act 381), the operator determining unit 304 determines that the store staff member deposited the coins to the coin change machine 271 (the store staff member is operating the self-service POS terminal 1) (Act 382).

If determining that the key is not inserted into the key hole 285 or the position of the key inserted into the key hole 285 is not the position of the deposit mode (No in Act 381), the operator determining unit 304 determines whether predetermined operation for changing the coin change machine 271 to the deposit mode was performed using the operation unit 38 (Act 383). If determining that the predetermined operation for changing the coin change machine 271 to the deposit mode was performed using the operation unit 38 (Yes in Act 383), the operator determining unit 304 determines that the store staff member deposited the coins to the coin change machine 271 (the store staff member is operating the self-service POS terminal 1) (Act 382).

If determining that the predetermine operation was not performed (No in Act 383), the operator determining unit 304 determines, based on output of the cover sensor 44, whether the cover 279 is attached to the receiving port 278 (Act 384). If determining that the cover 279 is attached to the receiving port 278 (Yes in Act 384), the operator determining unit 304 determines that the store staff member deposited the coins to the coin change machine 271 (the store staff member is operating the self-service POS terminal 1) (Act 382).

If determining that the cover 279 is not attached to the receiving port 278 (No in Act 384), the operator determining unit 304 determines whether a supply command for supplying coins was received from the self-service POS terminal 1 (Act 385). If determining that the supply command for supplying coins was received from the self-service POS terminal 1 (Yes in Act 385), the operator determining unit 304 determines that the store staff member deposited the coins to the coin change machine 271 (the store staff member is operating the self-service POS terminal 1) (Act 382).

If determining that the supply command for supplying coins was not received from the self-service POS terminal 1 (No in Act 385), the operator determining unit 304 determines whether deposit information was received from the self-service POS terminal 1 (Act 386). If determining that deposit information was not received from the self-service POS terminal 1 (No in Act 386), the operator determining unit 304 determines that the store staff member deposited the coins to the coin change machine 271 (the store staff member is operating the self-service POS terminal 1) (Act 382).

If determining that deposit information was received from the self-service POS terminal 1 (Yes in Act 386), the operator determining unit 304 determines that the customer deposited the coins to the coin change machine 271 (the customer is operating the self-service POS terminal 1) (Act 387).

That is, in an example illustrated in FIG. 11, if determining that the key is inserted and located in the predetermined position, determining that the predetermined operation for changing the coin change machine 271 to the deposit mode was performed using the operation unit 38, determining that the cover 279 is attached to the receiving port 278, determining that the supply command for supplying coins was received from the self-service POS terminal 1, or determining that deposit information was received from the self-service POS terminal 1, the operator determining unit 304 determines that the store staff member deposited the coins to the coin change machine 271 (the store staff member is operating the self-service POS terminal 1). On the other hand, if determining that the key is not inserted or is located in another position, determining that the predetermined operation for changing the coin change machine 271 to the deposit mode was not performed using the operation unit 38, determining that the cover 279 was not attached to the receiving port 278, determining that the supply command for supplying coins was not received from the self-service POS terminal 1, and determining that deposit information was received from the self-service POS terminal 1, the operator determining unit 304 determines that the customer deposited the coins to the coin change machine 271 (the customer is operating the self-service POS terminal 1).

Referring back to FIG. 10, if determining in Act 31 that the coins were not deposited to the receiving port 278 (No in Act 31), the control unit 300 determines whether change amount information was received from the self-service POS terminal 1 (Act 41). If determining that change amount information for the coins was received from the self-service POS terminal 1 (Yes in Act 41), the control unit 300 drives the dispensing motor 40 and dispenses coins of an amount based on the received change amount information to the coin tray 273 (Act 42). The control unit 300 ends the processing.

If determining that change amount information was not received from the self-service POS terminal 1 (No in Act 41), the control unit 300 returns to Act 31.

The coin change machine 271 in the embodiment explained above determines which of the customer and the store staff member deposited the coins to the coin change machine 271 and, if determining that the customer deposited the coins, returns coins exceeding the limit number of coins in one transaction to the coin reject unit 276. If determining that the store staff member deposited the coins, the coin change machine 271 does not return coins exceeding the limit number of coins in one transaction. As explained above, the coin change machine 271 limits the number of coins if the customer deposited coins exceeding the limit number and does not limit the number of coins if the store staff member deposited coins exceeding the limit number. Accordingly, the store staff member can perform depositing work for, for example, supplying coins exceeding the limit number to the coin change machine 271.

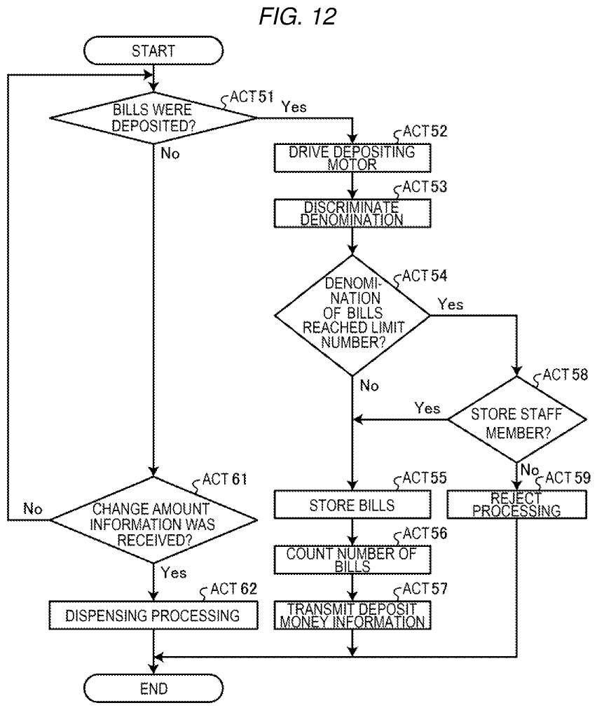

Subsequently, control for the bill change machine 272 is explained. FIG. 12 is a flowchart illustrating a flow of control processing for the bill change machine 272. As illustrated in FIG. 12, the control unit 700 of the bill change machine 272 determines whether bills were deposited to the bill receiving port 274 (Act 51). If the receiving sensor 81 performs output indicating that bills were deposited to the bill receiving port 274, the control unit 700 determines that bills were deposited to the bill receiving port 274. If determining that bills were deposited to the bill receiving port 274 (Yes in Act 51), the control unit 700 derives the depositing motor 79 and carries the bills deposited to the bill receiving port 274 into the bill change machine 272 (Act 52).

Subsequently, the denomination discriminating unit 701 drives the denomination discrimination sensor 82 and determines a denomination of carried-in one bill (Act 53). Subsequently, the number determining unit 703 determines, about the bills of the denomination determined by the denomination discriminating unit 701, whether the number of counts of the bills stored in the deposit money information unit 731 reached the limit number stored in the limit number unit 742 (Act 54). If determining that the number of counts did not reach the limit number (No in Act 54), the control unit 700 stores the bills in the bill storing unit (Act 55). If the bills are stored in the bill storing unit, based on output indicating that the counting sensor 83 detected the bills, the counting unit 702 increments, by one, the number of counts of the bills of the denomination discriminated by the denomination discriminating unit 701 in the number of counts of the bills stored in the deposit money information unit 731 (Act 56). The control unit 700 transmits deposit money information including an amount and the number of the bills (one) stored in the bill storing unit to the self-service POS terminal 1 (Act 57). The control unit 700 ends the processing and returns to Act 51 and executes the same processing for a bill carried in next.

If determining that the number of counts reached the limit number (Yes in Act 54), the operator determining unit 704 determines which of the customer and the store staff member deposited the bills to the bill change machine 272 (that is, whether the operator of the self-service POS terminal 1 is the customer or the store staff member) (Act 58). If the operator determining unit 704 determines that the customer deposited the bills to the bill change machine 272 (No in Act 58), the deposit control unit 705 drives the reject solenoid 84, performs reject processing for dropping the carried-in bill and dispensing the bill to the bill reject unit 277, and returns the bill to the customer (Act 59). The control unit 700 ends the processing and returns to Act 51 and executes the same processing for a bill carried in next.

Note that, if the reject processing was performed, the control unit 700 desirably transmits message information indicating the return of the bill and a reason for the return (the number of paid bills reached the limit number) to the self-service POS terminal 1 such that the self-service POS terminal 1 displays the message information. If the self-service POS terminal 1 displays the message, the customer can deposit another bill that is not the returned bill.

If the operator determining unit 704 determines that the store staff member deposited the bills to the bill change machine 272 (Yes in Act 58), the deposit control unit 705 executes the processing in Act 55 for storing the bills in the bill storing unit and, thereafter, executes the processing in Act 56 and Act 57. That is, the deposit control unit 705 stores the bills of the denomination in the bill storing unit even after the number of bills reached the limit number. The control unit 700 ends the processing and returns to Act 51 and executes the same processing for a bill carried in next.

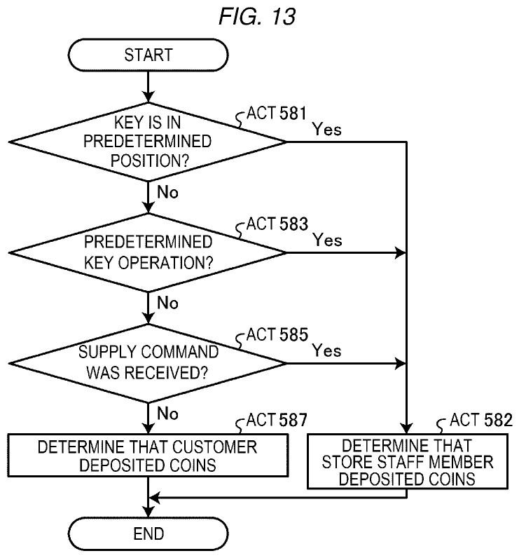

FIG. 13 is a flowchart illustrating a flow of control processing for operator determination in the bill change machine 272 executed in Act 58 by the operator determining unit 704. As illustrated in FIG. 13, the operator determining unit 704 determines whether the key is not inserted into the key hole 280 or is inserted and located in the predetermined position (Act 581). If the key is inserted and located in the predetermined position (Yes in Act 581), the operator determining unit 704 determines that the store staff member deposited the bills to the bill change machine 272 (the store staff member is operating the self-service POS terminal 1) (Act 582).

If determining that the key is not inserted into the key hole 280 (No in Act 581), the operator determining unit 704 determines whether predetermined operation for changing the bill change machine 272 to the deposit mode was performed using the operation unit 78 (Act 583). If determining that the predetermined operation for changing the bill change machine 272 to the deposit mode was performed using the operation unit 78 (Yes in Act 583), the operator determining unit 704 determines that the store staff member deposited the bills to the bill change machine 272 (the store staff member is operating the self-service POS terminal 1) (Act 582).

If determining that the predetermine operation was not performed (No in Act 583), the operator determining unit 704 determines a supply command for supplying bills was received from the self-service POS terminal 1 (Act 585). If determining that the supply command for supplying bills was received from the self-service POS terminal 1 (Yes in Act 585), the operator determining unit 704 determines that the store staff member deposited the bills to the bill change machine 272 (the store staff member is operating the self-service POS terminal 1) (Act 582).

If determining that the supply command for supplying bills was not received from the self-service POS terminal 1 (No in Act 585), the operator determining unit 704 determines that the customer deposited the bills to the bill change machine 272 (the customer is operating the self-service POS terminal 1) (Act 587).

That is, in an example illustrated in FIG. 13, if determining that the key is inserted and located in the predetermined position, determining that the predetermined operation for changing the bill change machine 272 to the deposit mode was performed using the operation unit 78, or determining that the supply command for supplying bills was received from the self-service POS terminal 1, the operator determining unit 704 determines that the store staff member deposited the bills to the bill change machine 272 (the store staff member is operating the self-service POS terminal 1). On the other hand, if determining that the key is not inserted or the key is located in a position other than the position of the deposit mode, determining that the predetermined operation for changing the bill change machine 272 to the deposit mode was not performed using the operation unit 78, and determining that the supply command for supplying bills was not received from the self-service POS terminal 1, the operator determining unit 704 determines that the customer deposited the bills to the bill change machine 272 (the customer is operating the self-service POS terminal 1).

Referring back to FIG. 12, if determining in Act 51 that the bills were not deposited to the bill receiving port 274 (No in Act 51), the control unit 700 determines whether change amount information was received from the self-service POS terminal 1 (Act 61). If determining that change amount information for the bills was received from the self-service POS terminal 1 (Yes in Act 61), the control unit 700 drives the dispensing motor 80 and dispenses bills of an amount based on the received change amount information to the bill dispensing port 275 (Act 62). The control unit 700 ends the processing.

If determining that change amount information was not received from the self-service POS terminal 1 (No in Act 61), the control unit 700 returns to Act 51.

The bill change machine 272 in the embodiment explained above determines which of the customer and the store staff member deposited the bills to the bill change machine 272 and, if determining that the customer deposited the bills, returns bills exceeding the limit number of bills in one transaction to the bill reject unit 277. If determining that the store staff member deposited the bills, the bill change machine 272 does not return bills exceeding the limit number of bills in one transaction. As explained above, the bill change machine 272 limits the number of bills if the customer deposited bills exceeding the limit number and does not limit the number of bills if the store staff member deposited bills exceeding the limit number. Accordingly, the store staff member can perform depositing work for, for example, supplying bills exceeding the limit number to the bill change machine 272.

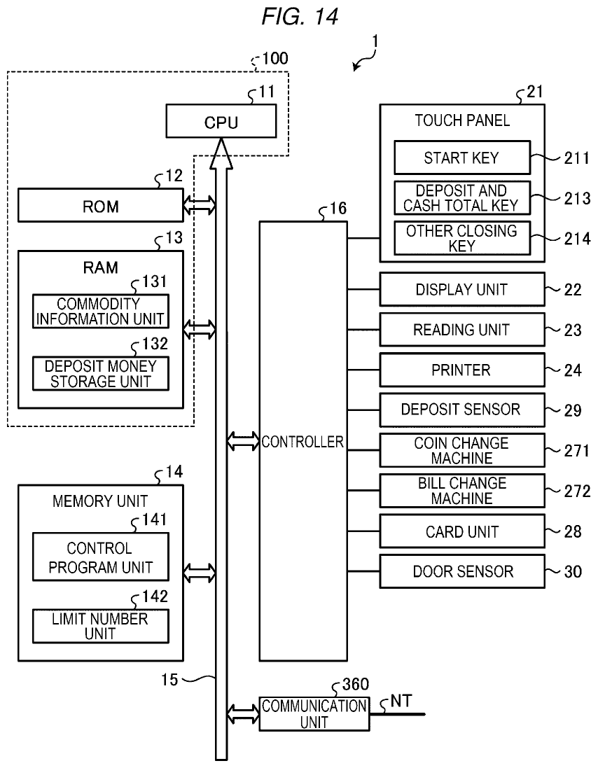

As explained above, in the embodiment, the coin change machine 271 includes the operator determining unit 304 and the bill change machine 272 includes the operator determining unit 704. The operator determining units 304 and 704 determine which of the customer and the store staff member deposited coins and bills. Another embodiment in which the self-service POS terminal 1 determines which of a customer and a store staff member deposited coins and bills to the self-service POS terminal 1 is explained with reference to FIGS. 14 to 20.

An object of the other embodiment is to provide a checkout device that limits the numbers of coins and bills if the customer deposited coins and bills exceeding limit numbers and does not limit the numbers of coins and bills if the store staff member deposited coins and bills exceeding the limit numbers. Note that, in the other embodiment, components that are the same as or similar to the components in the embodiment explained above are denoted by the same reference numerals and signs in FIGS. 14 to 20. Explanation of the components is omitted or simplified.

FIG. 14 is a block diagram illustrating a hardware configuration of the self-service POS terminal 1 according to the other embodiment. As illustrated in FIG. 14, the memory unit 14 includes a limit number unit 142. The limit number unit 142 stores, for each of denominations of coins and bills, a limit number of coins that can be deposited to the coin change machine 271 in one transaction and a limit number of bills that can be deposited to the bill change machine 272 in one transaction.

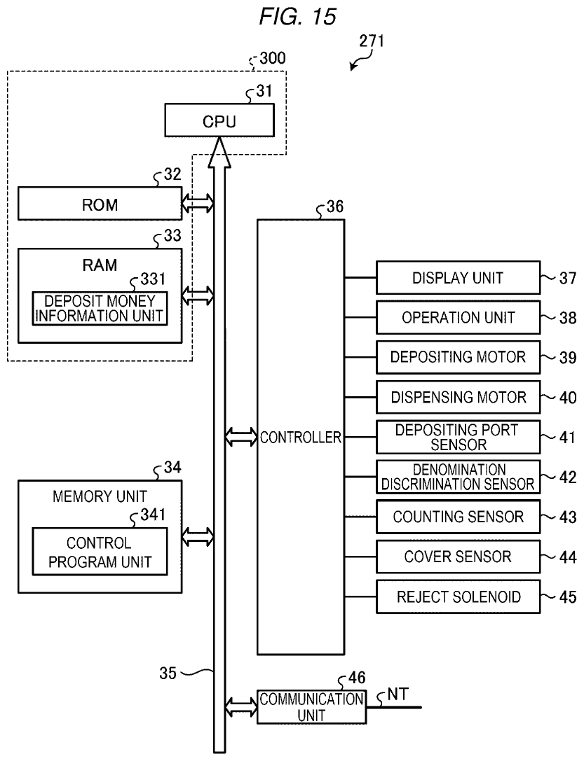

FIG. 15 is a block diagram illustrating a hardware configuration of the coin change machine 271 according to the other embodiment. As illustrated in FIG. 15, the memory unit 34 does not include the limit number unit 342. The reject solenoid 45 discharges deposited heterogenous coins and deformed coins to the coin reject unit 276 but once stores coins exceeding the limit number in the coin storing unit of the coin change machine 271 and does not return the coins to the coin reject unit 276.

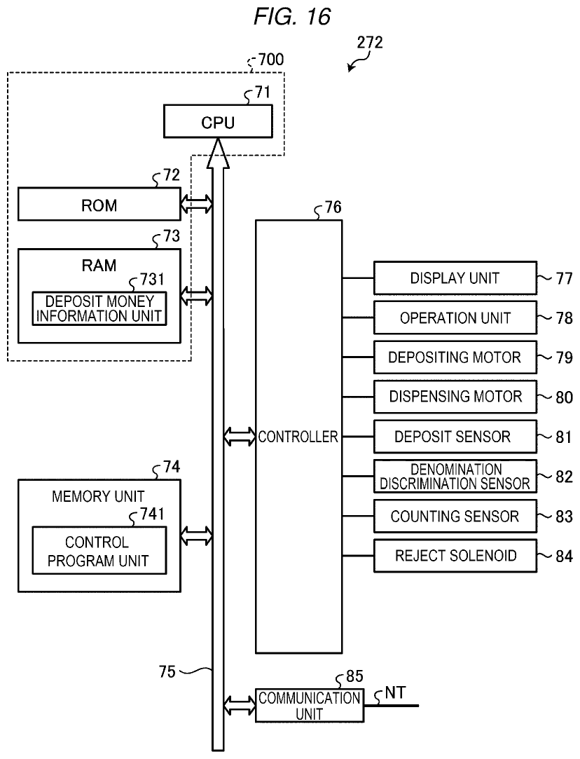

FIG. 16 is a block diagram illustrating a hardware configuration of the bill change machine 272 according to the other embodiment. As illustrated in FIG. 16, the memory unit 74 does not include the limit number unit 742. The reject solenoid 84 discharges deposited heterogeneous bills and deformed bills to the bill reject unit 277 but once stores bills exceeding the limit number in the bill storing unit of the bill change machine 272 and does not return the bills to the bill reject unit 277.

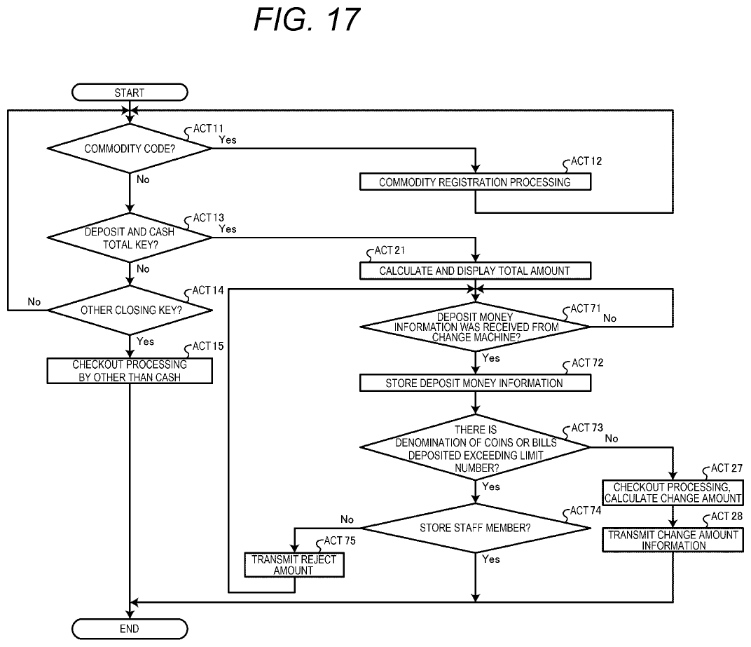

FIG. 17 is a flowchart illustrating a flow of control processing for the self-service POS terminal 1 according to the other embodiment. As illustrated in FIG. 17, after calculating and displaying the total amount (Act 21), the control unit 100 determines whether deposit money information (information concerning denominations of deposited coins and the numbers of deposited coins for each of the denominations, information concerning a total amount (deposit money) of the deposited coins, information received from the coin change machine 271 for the self-service POS terminal 1 to determine which of the customer and the store staff member deposited coins to the coin change machine 271, the information being a position of the key inserted into key hole 285 (if the key is not inserted into the key hole 285, including information to that effect), information concerning whether operation for changing to the coin change machine 271 to the deposit mode was performed in the operation unit 38, and information concerning whether the cover 279 is attached to the receiving port 278) was received from the coin change machine 271 (Act 71).

The control unit 100 determines whether deposit money information (information concerning denominations of deposited bills and the numbers of deposited bills for each of the denominations, information concerning a total amount (deposit money) of the deposited bills, information received from the bill change machine 272 for the self-service POS terminal 1 to determine which of the customer and the store staff member deposited bills to the bill change machine 272, the information being a position of the key inserted into key hole 280 (if the key is not inserted into the key hole 280, including information to that effect), and information concerning whether operation for changing to the bill change machine 272 to the deposit mode was performed in the operation unit 78) was received from the bill change machine 272 (Act 71). The control unit 100 stays on standby until the deposit money information is received. If determining that deposit money information is received, the control unit 100 stores, in the deposit money information unit 731, the deposit money information received from the coin change machine 271 and the bill change machine 272 (Act 72).

Subsequently, the control unit 100 (the number determining unit) determines, based on the received deposit money information, whether there is a denomination of coins or bills deposited exceeding the limit number (Act 73). If determining that there is no denomination deposited exceeding the limit number (No in Act 73), the control unit 100 executes checkout processing based on the total amount information and the received deposit money information (Act 27) and, if there is change, calculates a change amount (Act 27). The control unit 100 transmits change amount information of the calculated change amount to at least one of the coin change machine 271 and the bill change machine 272 (Act 28). If a change amount of coins is included in the change amount information, the control unit 100 transmits change amount information indicating change for the coins in the change amount to the coin change machine 271. If a change amount of bills is included in the change amount information, the control unit 100 transmits change amount information indicating change for the bills in the change amount to the bill change machine 272. The control unit 100 ends the processing.

If determining that there is a denomination deposited exceeding the limit number (Yes in Act 73), the control unit 100 (the operator determining unit) determines, based on the received deposit money information and other information, which of the customer and the store staff member deposited coins or bills to the coin change machine 271 or the bill change machine 272 (Act 74).

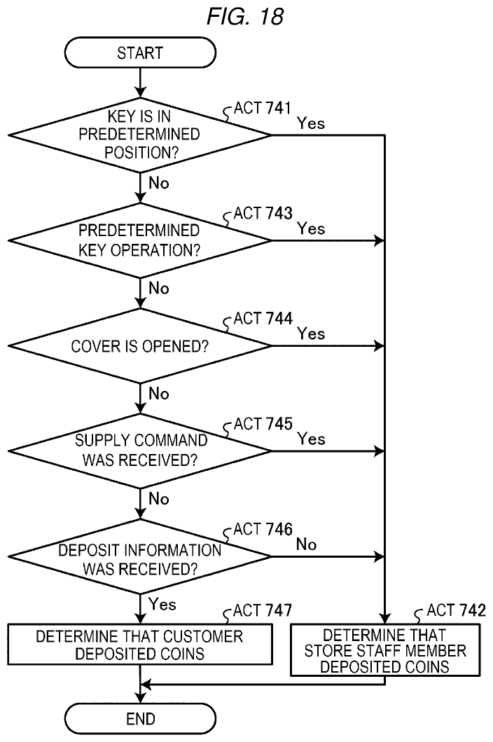

Here, operator determination for determining in Act 74 which of the customer and the store staff member deposited the coins or the bills is explained. FIG. 18 is a flowchart illustrating a flow of control processing for operator determination in the self-service POS terminal 1. As illustrated in FIG. 18, the control unit 100 (the operator determining unit) determines, based on the deposit money information received from the coin change machine 271, whether the position of the key inserted into the key hole 285 of the coin change machine 271 is the position of the deposit mode (Act 741). The control unit 100 (the operator determining unit) determines, based on the deposit money information received from the bill change machine 272, whether the position of the key inserted into the key hole 280 of the bill change machine 272 is the position of the deposit mode (Act 741). If at least one of the position of the key inserted into the key hole 285 and the position of the key inserted into the key hole 280 is the position of the deposit mode (Yes in Act 741), the control unit 100 (the operator determining unit) determines that the store staff member deposited the coins or the bills (Act 742).

If determining that both of the positions of the keys inserted into the key hole 285 and the key hole 280 are not the position of the deposit mode or the keys are not inserted into the key hole 285 and the key hole 280 (No in Act 741), the control unit 100 (the operator determining unit) determines, based on the deposit money information received from the coin change machine 271 or the bill change machine 272, whether a predetermined key of the operation unit 38 of the coin change machine 271 was operated to change the coin change machine 271 to the deposit mode or a predetermined key of the operation unit 78 of the bill change machine 272 was operated to change the bill change machine 272 to the deposit mode (Act 743). If determining that at least one of the coin change machine 271 and the bill change machine 272 was changed to the deposit mode (Yes in Act 743), the control unit 100 (the operator determining unit) determines whether the store staff member deposited the coins or the bills (Act 742).

If determining that both of the coin change machine 271 and the bill change machine 272 are not in the deposit mode (No in Act 743), the control unit 100 (the operator determining unit) determines, based on the deposit money information received from the coin change machine 271, whether the cover 279 is attached to the receiving port 278 (Act 744). If determining that the cover 279 is attached to the receiving port 278 (Yes in Act 744), the control unit 100 (the operator determining unit) determines that the store staff member deposited the coins (Act 742).

If determining that the cover 279 is not attached to the receiving port 278 (No in Act 744), the control unit 100 (the operator determining unit) determines whether a supply command for instructing to supply coins or bills was transmitted from the self-service POS terminal 1 to at least one of the coin change machine 271 and the bill change machine 272 (Act 745). If the supply command was transmitted, the supply command is stored in the RAM 13. Therefore, if the supply command for instructing to supply coins or bills is stored in the RAM 13, the control unit 100 (the operator determining unit) determines in Act 375 that the supply command for instructing to supply coins or bills was transmitted. If determining that the supply command was transmitted (Yes in Act 745), the control unit 100 (the operator determining unit) determines that the store staff member deposited the coins or the bills (Act 742).

If determining that the supply command for instructing to supply coins or bills was not transmitted (No in Act 745), the control unit 100 (the operator determining unit) determines whether deposit information indicating that the deposit sensor 29 detected that coins were deposited to the depositing port 284 was output (Act 746). If determining that the deposit information was output (Yes in Act 746), the control unit 100 (the operator determining unit) determines that the customer deposited the coins (Act 747).

If determining that the deposit information was not output (NO in Act 746), the control unit 100 (the operator determining unit) determines that the store staff member deposited the coins (Act 742).

That is, if at least one of the position of the key inserted into the key hole 285 and the position of the key inserted into the key hole 280 is the position of the deposit mode, if at least one of the coin change machine 271 and the bill change machine 272 was changed to the deposit mode by operation of a button, if the cover 279 is attached to the receiving port 278 of the coin change machine 271, if the supply command was transmitted to at least one of the coin change machine 271 and the bill change machine 272, and if the coins were deposited to the depositing port 284 of the coin change machine 271, the control unit 100 (the operation determining unit) determines that the store staff member deposited the coins or the bills. In none of these cases, the control unit 100 (the operator determining unit) determines that the customer deposited the coins or the bills.

Referring back to FIG. 17, if determining that the store staff member deposited the coins or the bills (Yes in Act 74), the control unit 100 (the operator determining unit) ends the processing. That is, if the store staff member deposited the coins or the bills, the coin change machine 271 receives all the deposited coins or the bill change machine 272 receives all the deposited bills.

If determining that the customer deposited the coins or the bills to the coin change machine 271 or the bill change machine 272 (No in Act 74), the control unit 100 (the operator determining unit) transmits, about the denomination exceeding the limit number, reject amount information including information concerning the number of coins or bills exceeding the limit number and a return command for returning the coins or the bills exceeding the limit number (Act 75). If coins are included in the denomination exceeding the limit number, the control unit 100 (the operator determining unit) transmits reject amount information including information concerning the number of coins of the denomination to the coin change machine 271. If bills are included in the denomination exceeding the limit number, the control unit 100 (the operator determining unit) transmits reject amount information including information concerning the number of bills of the denomination to the bill change machine 272. The control unit 100 returns to Act 71 and waits for deposit money information to be received again. Note that, if receiving deposit money information again through the processing in Act 75 (Yes in Act 71), in the processing in Act 72, the control unit 100 adds the received deposit money information to the deposit money information stored in the deposit money information unit 731 before and stores the received deposit money information.

If determining that there is no denomination of coins and bills deposited exceeding the limit number (No in Act 73), the control unit 100 executes the processing in Act 27 and subsequent acts if the deposit money stored in the deposit money information unit 731 is equal to or more than the total amount.

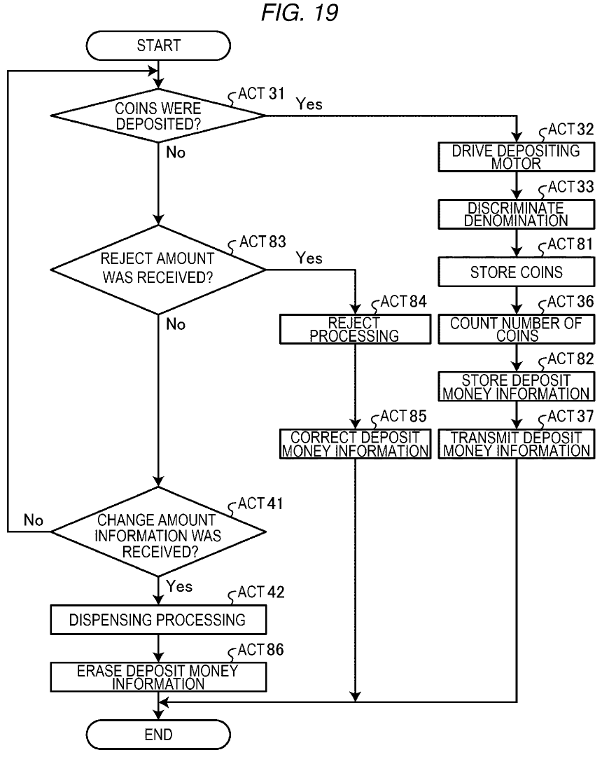

FIG. 19 is a flowchart illustrating a flow of control processing for the coin change machine 271 according to the other embodiment. In FIG. 19, the control unit 300 discriminates denominations of the deposited coins (Act 33) and stores the deposited all coins (excluding heterogeneous coins and deformed coins) in the coin storing unit (Act 81). In this case, the control unit 300 counts the numbers of the deposited coins for each of the denominations in Act 36. However, since the control unit 300 does not determine denominations of the numbers of coins exceeding the limit number, even if there are denominations of the coins deposited by the numbers exceeding the limit number, all of the coins are also stored in the coin storing unit. The control unit 300 stores the deposit money information concerning the deposit in the deposit money information unit 331 (Act 82).

If determining in Act 31 that coins were not deposited (No in Act 31), the control unit 300 determines whether reject amount information was received from the self-service POS terminal 1 (Act 83). If determining that the reject amount information was received from the self-service POS terminal 1 (Yes in Act 83), the control unit 300 dispenses, based on information of denominations and the numbers of coins included in the received reject amount information, coins equivalent to the numbers of coins of the denominations to the coin tray 273 (returns the numbers of coins exceeding the limit number) (Act 84). The control unit 300 corrects the deposit money information stored in the deposit money information unit 331 (Act 85). That is, the control unit 300 corrects the deposit money information stored in the deposit money information unit 331 to subtract the dispensed number of coins from the number information of the dispensed coins. The control unit 300 ends the processing.

If the change amount information is received (Yes in Act 41), after dispensing coins based on the change amount information as change (Act 42), the control unit 300 erases the deposit money information stored in the deposit money information unit 331 (Act 86).

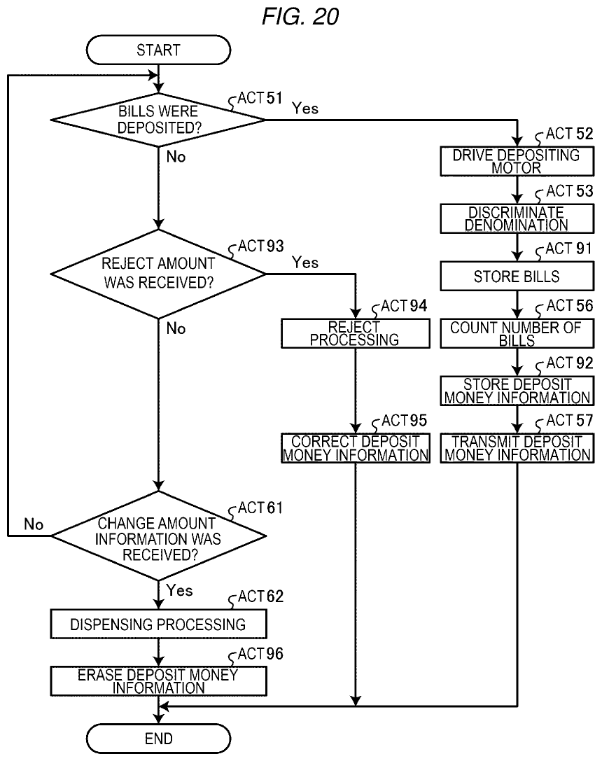

FIG. 20 is a flowchart illustrating a flow of control processing for the bill change machine 272 according to the other embodiment. In FIG. 20, the control unit 700 discriminates denominations of deposited bills (Act 53) and stores the deposited all bills (excluding heterogeneous bills and deformed bills) in the bill storing unit (Act 91). In this case, the control unit 700 counts the numbers of the deposited bills for each of the denominations in Act 56. However, since the control unit 700 does not determine denominations of the numbers of bills exceeding the limit number, even if there are denominations of the number of bills deposited exceeding the limit number, all of the bills are also stored in the bill storing unit. The control unit 700 stores the deposit money information concerning the deposit in the deposit money information unit 731.

If determining in Act 51 that bills were not deposited (No in Act 51), the control unit 700 determines whether reject amount information was received from the self-service POS terminal 1 (Act 93). If determining that the reject amount information was received from the self-service POS terminal 1 (Yes in Act 93), the control unit 700 dispenses, based on information of denominations and the numbers of bills included in the received reject amount information, bills equivalent to the numbers of bills of the denominations to the bill dispensing port 275 (returns the numbers of bills exceeding the limit number) (Act 94). The control unit 700 corrects the deposit money information stored in the deposit money information unit 731 (Act 95). That is, the control unit 700 corrects the deposit money information stored in the deposit money information unit 731 to subtract the dispensed number of bills from the number information of the dispensed bills. The control unit 700 ends the processing.

If the change amount information is received (Yes in Act 61), after dispensing bills based on the change amount information as change (Act 62), the control unit 700 erases the deposit money information stored in the deposit money information unit 731 (Act 96).

Claims relating to the other embodiment are noted below.

### Notes

### [Claim 1]

A checkout device comprising:
a change machine capable of receiving coins or bills deposited for purchase of a commodity and storing the coins or the bills in a storing unit and configured to dispense the stored coins or bills as change and output information concerning deposit numbers for each of denominations of the coins or the bills deposited in one transaction;
a storing unit configured to store a limit number of the coins or the bills for each of the denominations;
a number determining unit configured to determine, based on the information concerning the deposit numbers input from the change machine, whether there the coins or the bills of the denomination exceeding the limit number;
an operator determining unit configured to determine which of a customer and a store staff member deposited the coins or the bills to the change machine; and
a returning unit configured to, if the number determining unit determines that there are the coins or the bills of the denomination exceeding the limit number and the operator determining unit determines that the checkout device is operated by the customer, cause the change machine to return the coins or the bills stored in the storing unit equivalent to the exceeding number relating to the denomination exceeding the limit number.

### [Claim 2]

The device according to claim 1, wherein, if any one of a plurality of kinds of conditions is satisfied, the operator determining unit determines that the store staff member deposited the coins or the bills and, if all of the plurality of kinds of conditions are not satisfied, the operator determining unit determines that the customer deposited the coins or the bills.

### [Claim 3]

The device according to claim 1, wherein the change machine is a coin change machine to which the coins are deposited.

The embodiments are explained above. However, the embodiments are presented as examples and are not intended to limit the scope of the invention. The new embodiments can be implemented in other various forms. Various omissions, substitutions, and changes can be made without departing from the gist of the invention. The embodiments and modifications thereof are included in the scope and the gist of the invention and included in the inventions described in the claims and a scope of equivalents of the inventions.

For example, in the embodiment, the coin change machine 271 and the bill change machine 272 are examples of the change machine according to the embodiments. However, not only this, but one of the coin change machine 271 and the bill change machine 272 may be the change machine according to the embodiments. In many cases, a large quantity of coins are deposited. Therefore, the coin change machine 271 is desirably the change machine according to the embodiments.

In the embodiment, after the numbers of coins and the bills reached the limit numbers, the coins and the bills are discharged to the coin reject unit 276 and the bill reject unit 277. However, not only this, but, for example, all of the coins and the bills may be once stored in the storing units and the coins and the bills exceeding the limit numbers may be dispensed to the coin tray 273 and the bill dispensing port 275.

In the embodiment, the deposit money information is transmitted to the self-service POS terminal 1 every time one coin and one bill are deposited. However, not only this, but, for example, the deposit money information may be incrementally stored about all of the coins and the bills not rejected and, thereafter, the deposit money information collectively stored may be transmitted to the self-service POS terminal 1.

In the embodiment and the other embodiment, the self-service POS terminal 1 is explained as an example of the checkout device. However, not only this, but the checkout device may be a checkout device in a semi-self-service POS or may be a normal POS terminal operated by a store clerk and the like, the POS terminal being a type to which a customer deposits coins and bills as deposit money.

What is claimed is:

1. A change machine to which at least one of coins and bills relating to purchase of a commodity are deposited, the change machine comprising:
a denomination discriminating component configured to discriminate denominations of the deposited coins or bills;
a counting component configured to count a number of the coins or the bills for each of the discriminated denominations;
a storage component configured to store a limit number of the coins or the bills;
a number determining component configured to determine a denomination of the coins or the bills, the number of which counted in one transaction by the counting component reached the limit number;
an operator determining component configured to determine which of a customer and a store staff member deposited the coins or the bills; and
a deposit controller configured to, if the operator determining component determines that the customer deposited the coins or the bills, return the coins or the bills of the denomination after reaching the limit number and, if the operator determining component determines that the store staff member deposited the coins or the bills, allows storage of the coins or the bills of the denomination after reaching the limit number.

2. The change machine according to claim 1, wherein, if any one of a plurality of kinds of conditions is satisfied, the operator determining component determines that the store staff member deposited the coins or the bills and, if all of the plurality of kinds of conditions are not satisfied, the operator determining component determines that the customer deposited the coins or the bills.

3. The change machine according to claim 1, wherein the change machine is a coin change machine to which the coins are deposited.

4. The change machine according to claim 1, further comprising a key operation component configured to change operation content of the change machine to a deposit mode according to a turning position of a key inserted into the key operation component, wherein
if a position of the key in the key operation component is a position of the deposit mode, the operator determining component determines that the store staff member deposited the coins or the bills.

5. The change machine according to claim 1, further comprising a button operation component including one or a plurality of buttons, wherein
if operation for changing operation content of the change machine to a deposit mode was performed in the button operation component, the operator determining component determines that the store staff member deposited the coins or the bills.

6. The change machine according to claim 1, wherein the limit number of the coins is different from the limit number of the bills.

7. The change machine according to claim 1, wherein the limit number of a first denomination of coins or bills is different from the limit number of a second denomination of coins or bills.

8. A method of processing at least one of coins and bills relating to purchase of a commodity, comprising:
discriminating denominations of at least one of deposited coins and bills;
counting a number of the coins and the bills for each of the discriminated denominations;
storing a limit number of the coins and the bills;
determining a denomination of the coins and the bills, the number of which counted in one transaction by the counting reaches the limit number;
determining which of a customer and a store staff member deposited the coins and the bills; and
if determining that the customer deposited the coins or the bills, returning the coins or the bills of the denomination after reaching the limit number and, if the determining that the store staff member deposited the coins and the bills, allowing storage of the coins or the bills of the denomination after reaching the limit number.

9. The method according to claim 8, wherein, if any one of a plurality of kinds of conditions is satisfied, determining that the store staff member deposited the coins ands the bills and, if all of the plurality of kinds of conditions are not satisfied, determining that the customer deposited the coins and the bills.

10. The method according to claim 8, wherein the limit number of a first denomination of coins and bills is different from the limit number of a second denomination of coins and bills.

11. The method according to claim 8, further comprising:
changing operation content to a deposit mode according to a turning position of a key inserted into a key operation component; and
if a position of the key in the key operation component is a position of the deposit mode, determining that the store staff member deposited the coins or the bills.

12. The method according to claim 8, further comprising:
if operation for changing operation content to a deposit mode was performed in a button operation component, determining that the store staff member deposited the coins or the bills.

13. The method according to claim 8, wherein the limit number of the coins is different from the limit number of the bills.

14. A point of sales terminal, comprising:
a display component configured to display an amount of coins and bills deposited relating to purchase of a commodity;
a denomination discriminating component configured to discriminate denominations of the deposited coins and bills;
a counting component configured to count a number of the coins and the bills for each of the discriminated denominations;
a storage component configured to store a limit number of the coins and the bills;
a number determining component configured to determine a denomination of the coins and the bills, the number of which counted in one transaction by the counting component reached the limit number;
an operator determining component configured to determine which of a customer and a store staff member deposited the coins and the bills; and
a deposit controller configured to, if the operator determining component determines that the customer deposited the coins and the bills, return the coins and the bills of the denomination after reaching the limit number and, if the operator determining component determines that the store staff member deposited the coins and the bills, allows storage of the coins and the bills of the denomination after reaching the limit number.

15. The point of sales terminal according to claim 14, wherein, if any one of a plurality of kinds of conditions is satisfied, the operator determining component determines that the store staff member deposited the coins and the bills and, if all of the plurality of kinds of conditions are not satisfied, the operator determining component determines that the customer deposited the coins and the bills.

16. The point of sales terminal according to claim 14, wherein the point of sales is a coin change machine to which the coins are deposited.

17. The point of sales terminal according to claim 14, further comprising a key operation component configured to change operation content of the change machine to a deposit mode according to a turning position of a key inserted into the key operation component, wherein
if a position of the key in the key operation component is a position of the deposit mode, the operator determining component determines that the store staff member deposited the coins and the bills.

18. The point of sales terminal according to claim 14, further comprising a button operation component including one or a plurality of buttons, wherein
if operation for changing operation content to a deposit mode was performed in the button operation component, the operator determining component determines that the store staff member deposited the coins and the bills.

19. The point of sales terminal according to claim 14, wherein the limit number of the coins is different from the limit number of the bills.

20. The point of sales terminal according to claim 14, wherein the limit number of a first denomination of coins and bills is different from the limit number of a second denomination of coins and bills.
